(19) United States
(12) Patent Application Publication
(10) Pub. No.: US 2026/0352114 A1
(43) Pub. Date: Nov. 5, 2026

(54) FULLY INTEGRATED POWER INVERTER MODULE AND ELECTRIC MOTOR PRODUCED THEREFROM

(71) Applicant: L. Pierre de Rochemont, Austin, TX (US)

(72) Inventor: L. Pierre de Rochemont, Austin, TX (US)

(21) Appl. No.: 19/666,116

(22) Filed: May 1, 2026

Related U.S. Application Data
(60) Provisional application No. 63/798,730, filed on May 2, 2025.

(51) Int. Cl. H02M 7/217; H01F 27/24; H01F 27/28

(52) U.S. Cl. CPC H02M 7/217; H01F 27/24; H01F 27/28

(57) ABSTRACT

Design and construction of a circuit module designed to function as a high efficiency (DC-AC) power inverter circuit that minimizes the length of internal electrically conductive interconnections while reducing the weight and physical size of the power inverter circuit by integrating passive circuitry with active circuitry into a fully integrated monolithic solid state device and further a fully integrated inverter circuits, minimizing the physical size of elemental component, reducing internal power switching losses by power switching speeds to frequencies in excess of 2 GHz, regulating or optimizing the performance, of the fully integrated power inverter module in conjunction with other system or subsystem elements of vehicle's operation, and related features of product and process operation described and claimed herein.

### CROSS REFERENCE TO RELATED APPLICATIONS

This application claims priority to U.S. Provisional Patent Application No. 63/798,730, filed May 2, 2025, the contents of which is incorporated by reference herein in its entirety and for all purposes.

### FIELD OF THE INVENTION

The present invention relates generally to the design and construction of a circuit module designed to function as a high efficiency (DC-AC) power inverter circuit that minimizes the length of internal electrically conductive interconnections while reducing the weight and physical size of the power inverter circuit by integrating passive circuitry with active circuitry into a fully integrated monolithic solid state device.

The present invention further relates to the use of fully integrated inverter circuits in ground-based, airborne, and space-based vehicles that utilize battery, solar cell, or fuel cell sources to power vehicular propulsion or operational systems.

The present invention additionally relates to the use of a resonant gate transistor that minimizes the physical size of elemental component geometries that are integrated into the inverter circuit and other electronic systems.

The present invention further relates to the use of a resonant gate transistor that minimizes internal power switching losses by power switching speeds to frequencies in excess of 2 GHz.

The present invention further comprises a power inverter module that is integrated or mounted on a semiconductor device containing computer control circuitry that regulates or optimizes the performance of the fully integrated power inverter module in conjunction with other system or subsystem elements of vehicle's operation.

The present invention further alludes to the use of high efficiency thermoelectric power generation systems that are strategically located in an electric/hybrid motor or propulsion system to convert thermal differentials into electrical power that is redirected into an energy system or directly supplies the drive system.

The present invention further relates to the substitution of a transformer device with a gyrator circuit element that has been designed to function as a loss-less transformer element, wherein the gyrator circuit element may additional comprise resonant gate transistors within the construction of its internal operational amplifier circuitry.

The present invention further claims the fully integrated power inverter as a central element of an electric motor, a hybrid engine, or regenerative power generation platform.

The present invention additionally relates to the use of ultra-low loss magnetic cores that comprise layers of amorphous silica to minimize eddy current losses and comprise uniform grain size less than 7 micron (μm) in diameter to maximize permeability and minimize residual losses while increasing magnetic flux coupling to optimize the performance in a magnetic circuit.

The present invention relates to the integration of diamagnetic materials in optimal locations to optimize flux densities within the magnetic system.

The present invention further comprises a resonant gate transistor within the power switching elements of the gyrator circuitry that further comprise a broad band filtering stage embedded within the gate structure of the resonant gate transistor that optimizes the power efficiencies of the inverter and/or gyrator circuitry contained within the fully integrated power inverter module.

### 1. Background to the Invention

Electric vehicles (EVs) have been proposed as an automotive alternative to systems that rely on internal combustion engines (“ICE”) that operate on petroleum products. Market adoption has been limited to a 8.1% share despite massive propaganda and government subsidies. Consumers have been reluctant to embrace EV products because of their limited range on a battery charge, excessive recharging times, production costs that exceed market acceptable pricing, inadequate infrastructure, weather-related battery limitations and limited model variety. Low cost means that reduce the weight and improve the electrical efficiency of an electric motor or introduce novel means to harvest electrical power from waste heat generate by the EV or hybrid vehicle are clearly valuable to securing broader market adoption. Fully integrating systems and subsystems reduces part counts and assembly costs provide an avenue to aligning production costs with market acceptable pricing to satisfy another major vector for broader market adoption of these systems.

### 2. Overview of the Related Prior Art

The Swedish hyper-car manufacturer Koenigsegg leads the world in compact power efficiencies with its Quark electric motor that sets new benchmarks in providing high power and torque-rich engineering in a lightweight design. The Quark motor production unit produces up to 600 Newton-meters (Nm) of torque and 250 Kilo-Watts (kW) of power in a motor design that only weighs 28.8 kg (63.4 lbs).

Electric motors are classified either as radial or axial flux motors, depending upon whether the orientation of the stator's magnetic fields are directed along the rotor's radial or axial directions. Radial motors dominated markets during the EV early adoption phase, but axial motors are gaining popularity higher end performance applications because of their lighter weight and more compact size. The Koenigsegg Quark motor employs both radial and axial magnetic field components through a “raxial” design topology. No current design currently integrates inverter subsystems that transform DC voltages supplied by the battery into the AC voltages needed to drive the electric power train. Therefore, means to integrate subsystems into the motor system to reduce part count and associated inventory, logistical/supply and assembly costs as well as system weight are beneficial to improving the commercial competitiveness of EVs motors and hybrid engines.

de Rochemont U.S. Pat. No. 8,715,839, filed Jun. 30, 2006, entitled “ELECTRICAL COMPONENT AND METHOD OF MANUFACTURE” (the '839 application) discloses the integration of capacitive components with properties that remain stable with temperature upon a semiconductor or dielectric surface to form an integrated interconnect. It does not disclose embedding equalization circuitry and amplification stages within the semiconductor substrate to form a low loss I/O channel with high signal integrity and high power efficiency.

de Rochemont U.S. Pat. No. 7,405,698 entitled “CERAMIC ANTENNA MODULE AND METHODS OF MANUFACTURE THEREOF” (the '698 application) discloses the use of high permittivity electroceramic to form transmission lines that have characteristic impedance that matches the input/output impedance of a semiconductor chip, and the integration of those transmission lines on the surface of a semiconductor die or electrical interconnect (interposer circuit), but it does not disclose art related to transmission lines that comprise high permittivity and high permeability dielectrics configured along the path of a transmission line that causes the transmission line to resonate a given frequency or desired clock speed.

de Rochemont U.S. Ser. No. 15/521,145, filed with a priority date May 2, 2017, entitled “HIGH SPEED SEMICONDUCTOR CHIP STACK” (the '145 application) discloses and claims high permittivity electroceramics that have dielectric properties that remain stable with temperature and time (above femto-second time scales) by virtue of having uniform nanoscale grain size and microstructure. It also discloses the incorporation of those high permittivity electroceramics within surface layers formed upon an interposer circuit or semiconductor die that are embedded within the high speed semiconductor chip stack. While it claims the use of these materials at a via, either around a via pad as an integral part of the via pad or adjacent to a via pad to minimize signal reflections, it does not disclose the use of these electroceramics as components to an equalization circuit around a via pad, vertically distributed among several via pads forming the via, or within a I/O channel.

### 3. Definition of Terms

The terms “1^{st} Generation Stack Machine” or “1^{st} Generation Stack Machine Information Architecture” are herein understood to refer to a stack processor information architecture wherein data remains resident in memory where a string of operators and operands pass through select memory addresses to obtain a desired algorithmic result.

The terms “2^{nd} Generation Stack Machine Architecture” or “2^{nd} Generation Stack Machine Architecture” are herein understood to refer to a stack processor information architecture wherein a string of operators and operands are called from memory into a stack machine processor designed to process algorithms using structured programming languages that utilize minimal instruction set (MISC) architectures to obtain the a desired algorithmic result and return it back to a specified location in memory.

The terms “3^{rd} Generation Stack Machine Architecture” or “3^{rd} Generation Stack Machine Information Architecture” are herein understood to refer to an information architecture having minimal or no dependence upon cache memory utilities wherein a controller maximizes algorithmic efficiencies by dynamically assigning data processing, when warranted, to memory using methods consistent with a 1^{st} Generation Stack Machine, or assigning data processing most efficiently resolved by recursive or deeply nested loop algorithms to a Stack Machine processor die using methods consistent with a 2^{nd} Generation Stack Machine and minimal instruction set computing (MISC) architectures, or assigning data processing most efficiently resolved by iterative algorithms to a central processing unit or graphical processing using reduced instruction set computing (RISC) architectures.

The term “average amu” is herein understood to mean the median atomic mass of a unit cell for a crystalline compound derived by summing the fractional atomic mass units contributed by elements forming the crystal lattice.

The term “BEOL” is herein understood to have its conventional meaning of “back end of line”, which refers to semiconductor processes that form the electrical interconnections between the active circuitry, such as switching elements, embedded within the semiconductor surface and any device or system to which the semiconductor is electrically connected.

The term “Big Nano” or “Big Nano phase” is herein understood to herein understood to refer to a macroscopically large polycrystalline material of a semiconductor, electroceramic, or metal/metal alloy/superalloy comprising a microstructure wherein each crystalline grain has identical compositional chemistry and uniform grain size that is less than or equal to 50 nm causing the collective bulk substance to exhibit physical properties limited to the quantum domain.

The terms “chemical complexity”, “compositional complexity”, “chemically complex”, or “compositionally complex” are herein understood to refer to a material, such as a metal or superalloy, compound semiconductor, or ceramic that consists of three (3) or more elements from the periodic table.

The term “chip stack” is herein understood to mean a bonded three dimensional (3D) assembly of chips that may comprise semiconductor die and non-semiconductor chip elements, such as sensors, micro-electromechanical systems (“MEMS”), and/or interposer circuits that provide passive electrical interconnections between the various components in the 3D assembly.

The term “critical performance tolerances” is herein understood to refer to the ability for all passive components in an electrical circuit to hold performance values within □1% of the desired values at all operating temperatures over which the circuit was designed to function.

The term “electroceramic” is herein understood to refer to its conventional meaning as being a complex ceramic material that has robust dielectric properties that augment the field densities of applied electrical or magnetic stimulus.

The term “high interconnection density” or “high I/O density” is herein understood to mean a linear escape density in excess of 200 IO/mm/layer, wherein linear escape density is the number of physical interconnects escaping per millimeter of semiconductor die edge for each layer of a packaging device.

The term “high-speed semiconductor chip stack” is herein understood to mean an assembly of two or more semiconductor chips with interposers comprising passive circuitry integrated on to the chip/interposers that comprise electroceramic capacitive elements in the Big Nano phase that maintain dielectric properties stable with temperature, frequency and time (aging) such that the chip stack may operate at optimal system clock speeds that are not limited by variances in the electrical interconnect structure of the stacked assembly.

The term “hybrid computer module” is herein understood to mean a computational circuit comprising a semiconductor carrier comprising integrated passive circuitry, electrical and electronic bus circuitry, in communication with a fully integrated power management device that manages the flow of data between CPU, GPU, memory, FPGA, controller chips and/or an electro-optic interface that are mounted on the semiconductor chip carrier either directly or within a high-speed semiconductor chip stack as instructed in.

The term “integrated circuit” (or “IC”) is herein understood to mean a semiconductor chip into which a large, very large, or ultra-large number of active switching element elements have been embedded.

The term “I/O channel” is herein understood to mean a conductive link between the output port of a first semiconductor chip and the input port of a second semiconductor chip and the intervening circuit elements necessary to optimize the integrity of signals transmitted between the two ports.

The term “liquid chemical deposition” (or “LCD”) is herein understood to mean a method that uses liquid precursor solutions to fabricate materials of arbitrary compositional or chemical complexity as an amorphous laminate or free-standing body or as a crystalline laminate or free-standing body that have atomic-scale chemical uniformity and a microstructure that is controllable down to nanoscale dimensions.

The term “MAX-phase material” is herein understood to define a chemically complex inter-metallic ceramic material having the general chemical formula M₍ₙ₊₁₎AXₙ, wherein Mis first row transition-metal element, A is an “A-group” element found in columns III-VI of the periodic table, and X is either carbon (C) or nitrogen (N).

The term “microstructure” is herein understood to hold its traditional meaning of relating to the grain size, grain chemistry, and grain boundary chemistry of a polycrystalline ceramic material.

The term “passive component” is herein understood to refer to its conventional definition as an element of an electrical circuit that that modulates the phase or amplitude of an electrical signal without producing power gain.

The term “physical layer” is herein understood to mean a patterned or unpatterned material layer embedded within a microelectronic circuit wherein the material possesses some unique physical property that enhances the proper function of the circuit or a circuit element.

The term “processor unit” is herein understood to mean any form of microprocessor, including a GPU, CPU, ARM, stack, embedded, video, audio, or application specific.

The term “resonant gate transistor” is herein understood to refer to any of the transistor architectures disclosed in de Rochemont, U.S. Pat. No. 8,779,489, “POWER FET WITH A RESONANT TRANSISTOR GATE”, wherein the transistor switching speed is not limited by the capacitance of the transistor gate, but operates at frequencies that cause the gate capacitance to resonate with inductive elements embedded within the gate structure.

The term “standard operating temperatures” is herein understood to mean the range of temperatures between −40 □C and +125 □C.

The term “surface feature” is herein understood to mean one or more patterned physical layers integrated on the surface of a substrate wherein the patterns and physical properties of the physical layers are designed to serve some functional purpose within a microelectronic circuit.

The term “thermoelectric effect” is herein understood to refer to its conventional definition as the physical phenomenon wherein a temperature differential applied across a material induces a voltage differential within that material, and/or an applied voltage differential across the material induces a temperature differential within that material.

The term “thermoelectric material” is herein understood to refer to its conventional definition as a solid material that exhibits the “thermoelectric effect”.

The term “thermomechanical” is herein understood to refer to its conventional definition as relating to properties induced or created by the simultaneous application of elevated temperature and mechanical force or pressure.

The term “thinned” is herein understood to refer to an interposer circuit, a sensor chip, or a semiconductor die that has been ground and chemical mechanically polished to reduce its original thickness to a lesser thickness, preferably a thickness on the order of 25 μm or less.

The term “thru via” or “via” is herein understood to refer to its conventional definition as relating to a vertical electrical connection that is made by filling a thru hole with an electrically conductive substance.

The terms “tight tolerance” or “critical tolerance” are herein understood to mean a performance value, such as a capacitance, inductance, or resistance that varies less than +1% over standard operating temperatures.

The term “transmission line” is herein understood, for the specific purpose of this application, to refer to any of the following: a microstrip, a stripline, ground-cladded stripline, ground-cladded dielectric waveguide, and a dielectric slab waveguide.

The term “via” is herein understood to mean any vertical interconnection that establishes electrical, electro-optical, or electro-radiation communication between horizontal planes of an electrical circuit.

### SUMMARY OF THE INVENTION

A packaged 3D stacked Semiconductor Chip Assembly comprising a high thermal conductivity/high expansion/mechanically soft metal thermal shunt layer consisting of silver to which one or more adjacent metallic/superalloy mechanical constraint layer(s) are deposited consisting of Super Invar that have a coefficient of expansion equivalent to heat generating semiconductor chips and acts to constrain the thermal expansion of the silver shunt layers upon which the Super Invar has been deposited on while the mechanically constrained silver shunt layers transport heat from the heat-generating semiconductor chips embedded within the stacked Semiconductor Chip Assembly from the 3D Semiconductor Chip Stack to a first cold thermal reservoir.

A packaged 3D Semiconductor Chip Assembly comprising Super Alloy Super Invar layers interleaved with silver layers that function as a constrained shunt layer and further comprises a uniform distribution of grains that has physical dimension <50 nm.

A Packaged 3D Semiconductor Chip Stack Assembly comprising a thermoelectric circuit inserted between the heat generating semiconductor chip and the mechanically constrained thermal shunt layers and transfers heat from one major surface hot thermal surface to a cold thermal reservoir through the interleaved mechanically constrained thermal shut layers.

A Packaged 3D Semiconductor Chip Stack Assembly comprising a thermoelectric circuit consisting of interleaving squares of n-doped and p-doped semiconductor material making sequential electrical connection wherein the semiconductor squares comprise a uniform distribution or grains having physical size <50 nm.

A Packaged 3D Semiconductor Chip Stack Assembly comprising a thermoelectric circuit wherein the n-doped and p-doped semiconductor square consist of Skutterite srmiconductor.

A Packaged 3D Semiconductor Chip Stack Assembly comprising a thermoelectric circuit wherein the semiconductor material comprises a Group-IV element.

A Package 3D Semiconductor Chip Stack Assembly comprising a thermoelectric circuit, wherein the Group IV element is limited to the grain core of the polycrystalline semiconductor, and the grain Boundary consists of a Group I Alkali Element, or more Group Alkali Elements, or a plurality of Alkali Elements and the thickness of the grain boundary layers is between 10 nm and 40 nm.

A Packaged 3D Semiconductor Chip Stack Assembly comprising thermoelectric circuit, wherein the heat transfer rate across the major surface of the thermoelectric circuit is >300 W-cm⁻².

A Package 3D Semiconductor Chip Stack Assembly comprising a thermoelectric circuit wherein the coefficient of efficiency of the thermoelectric circuit is ≥2.

### BRIEF DESCRIPTION OF THE DRAWINGS

The present invention is illustratively shown and described in reference to the accompanying drawings, in which:

FIG. 1 depicts the circuit schematic of a power inversion devise.

FIGS. 2A, 2B, 2C, 2D, 2E, 2F, 2G, 2H, 2I depict various stages of the construction of a fully integrated power inversion device in accordance with the claimed invention.

FIGS. 3A, 3B depict embodiments related to high power fully integrated power inversion as instructed by the claimed invention.

FIG. 4A illustrates the low-loss composite ferromagnetic core.

FIG. 4B depicts the method of construction of a composite ferromagnetic core.

FIG. 4C illustrates signal “ripple” generated by Eddy current losses in magnetic cores that are not subject to the invention.

FIG. 4D. depicts an electromagnet with a low-loss composite ferromagnetic core as instructed by the claimed invention.

FIGS. 5A, 5B, 5C, 5D, 5E illustrate various elements that claim embodiments related to electric motors subject to the invention.

FIGS. 6A, 6B, 6C illustrate means to improve signal integrity in a high speed semiconductor chip stack with active thermal management.

### DESCRIPTION OF THE PREFERRED EMBODIMENTS

The present invention is illustratively described above in reference to the disclosed embodiments. Various modifications and changes may be made to the disclosed embodiments by persons skilled in the art without departing from the scope of the present invention as defined in the appended claims.

This application incorporates by reference all matter contained in de Rochemont U.S. Pat. No. 7,405,698 entitled “CERAMIC ANTENNA MODULE AND METHODS OF MANUFACTURE THEREOF” (the '698 application), de Rochemont U.S. Pat. No. 8,715,839 filed Jun. 30, 2006, entitled “ELECTRICAL COMPONENT AND METHOD OF MANUFACTURE” (the '839 application), de Rochemont U.S. Pat. No. 8,350,657 (the '657 application), filed Jan. 6, 2007 entitled “POWER MANAGEMENT MODULE AND METHODS OF MANUFACTURE”, de Rochemont U.S. Ser. No. 14/560,935, (the '935 application), filed Dec. 4, 2014 entitled “POWER MANAGEMENT MODULE AND METHODS OF MANUFACTURE”, de Rochemont and Kovacs, U.S. Pat. No. 8,715,814, “LIQUID CHEMICAL DEPOSITION PROCESS APPARATUS AND EMBODIMENTS”, (the '814 application) and U.S. Pat. No. 8,354,294 (the '294 application), de Rochemont, “MONOLITHIC DC/DC POWER MANAGEMENT MODULE WITH SURFACE FET” U.S. Pat. No. 8,552,708 (the '708 application), de Rochemont, U.S. Pat. No. 8,749,054, “SEMICONDUCTOR CARRIER WITH VERTICAL POWER FET MODULE”, (the '054 application), de Rochemont U.S. Pat. No. 9,023,493, “CHEMICALLY COMPLEX ABLATIVE MAX-PHASE MATERIAL AND METHOD OF MANUFACTURE”, (the '493 application), de Rochemont U.S. Pat. Nos. 8,779,489 and 9,153,532, “POWER FET WITH A RESONANT TRANSISTOR GATE”, (the '489 and '532 application), de Rochemont U.S. Pat. No. 9,123,768, “SEMICONDUCTOR CHIP CARRIERS WITH MONOLITHICALLY INTEGRATED QUANTUM DOT DEVICES AND METHOD OF MANUFACTURE THEREOF”, (the '768 application), de Rochemont U.S. Pat. No. 8,952,858, “FREQUENCY-SELECTIVE DIPOLE ANTENNAS”, (the '858 application), de Rochemont and Kovacs U.S. Pat. No. 9,348,385, “HYBRID COMPUTING MODULE” (the '385 application), de Rochemont, U.S. Pat. No. 9,490,414, “FULLY INTEGRATED THERMOELECTRIC DEVICES AND THEIR APPLICATION TO AEROSPACE DE-ICING SYSTEMS”, (the '414 application), de Rochemont U.S. Ser. No. 15/958,706, “RESONANT HIGH ENERGY DENSITY STORAGE DEVICE”, (the '706 application), de Rochemont, U.S. Ser. No. 15/99,234, HIGH SPEED SEMICONDUCTOR CHIP STACK, (the '234 application), and de Rochemont U.S. Ser. No. 16/403,411, “HIGH SPEED/LOW POWER SERVER FARMS AND SERVER NETWORKS”, (the '411 application) and de Rochemont U.S. Ser. No. 16/432,691, “MODULE WITH HIGH-PEAK BANDWIDTH I/O CHANNELS” (the '691 application).

The '698 application instructs on methods and embodiments that provide meta-material dielectrics, including artificial magnetic ground planes, that have dielectric inclusion(s) with performance values that remain stable as a function of operating temperature. This is achieved by controlling the microstructure within dielectric inclusion(s) to nanoscale dimensions so they uniformly measure less than or equal to 50 nm. de Rochemont '839 instructs the integration of passive components that hold performance values that remain stable with temperature in printed circuit boards, semiconductor chip packages, wafer-scale SoC die, and power management systems. de Rochemont '159 instructs on how LCD is applied to form passive filtering networks and quarter wave transformers in radio frequency or wireless applications that are integrated into a printed circuit board, ceramic package, or semiconductor component. de Rochemont '657 instructs methods to form an adaptive inductor coil that can be integrated into a printed circuit board, ceramic package, or semiconductor device. de Rochemont et al. '814 discloses the liquid chemical deposition (LCD) process and apparatus used to produce macroscopically large compositionally complex materials, that consist of a theoretically dense network of polycrystalline microstructures comprising uniformly distributed grains with maximum dimensions less than 50 nm.

Complex materials are defined to include semiconductors, metals or super alloys, and metal oxide ceramics. de Rochemont '814 and '708 instruct on methods and embodiments related to a fully integrated low EMI, high power density inductor coil and/or high power density power management module. de Rochemont '489 and '532 instruct on methods to integrate a field effect transistor that switch arbitrarily large currents at arbitrarily high speeds with minimal On-resistance into a fully integrated silicon chip carrier. de Rochemont '768 instructs methods and embodiments to integrated semiconductor layers that produce a 3-dimensional electron gas within semiconductor chip carriers and monolithically integrated microelectronic modules. de Rochemont '302 instructs methods and embodiments to optimize thermoelectric device performance by integrating chemically complex semiconductor material having nanoscale microstructure. de Rochemont '858 instructs means to form a circuit resonant element by folding arms of dipole antenna or transmission line to induce inductive and capacitive loads through current vector coupling. The various embodiments and means claimed in the present application are constructed using liquid chemical deposition (LCD) methods instructed by de Rochemont et al. '814. de Rochemont '706 instructs the use of an electroceramic dielectric whose polarization response responds in phase with an applied electrical stimulus above femto-second (10-15 seconds), and the incorporation of the electroceramic dielectric within a resonant circuit. de Rochemont '234 instructs means to terminate transmission lines at a via by integrating high energy density electroceramic dielectric whose properties remain stable with temperature, frequency and time at time scales greater than femto-second time scales to minimize spurious signals generated at through silicon vias (TSVs). de Rochemont '411 instructs means to improve power efficiency of a server farm and regional/global network of server farms, does not instruct means to form equalizing circuitry or clock data recovery circuitry or to minimize inter-symbol-interference (ISI) within a high-speed chip stack. The '691 application instructs means to form equalizing circuitry or clock data recovery circuitry or to minimize inter-symbol-interference (ISI) within a high-speed chip stack and how to construct high-peak bandwidth input/output (I/O) channels and their use in a global server farm network and all nodes of communication interconnecting the server farm farms to an End-User device.

LCD methods permit the integration of high chemical complexity electroceramic dielectrics on a buried microelectronic layer with the requisite chemical precision to make the finished product economically viable. It enables chemically complex electroceramic dielectrics to be selectively deposited on a semiconductor surface at temperatures that do not damage embedded active circuitry buried within the semiconductor substrate. It further enables the integration of chemically complex electroceramic dielectrics with atomic scale chemical uniformity and uniform microstructure, including microstructure that has nanoscale uniformity irrespective of electroceramic dielectric chemical complexity. These electroceramic members are in their Big Nano material phase, wherein every grain within the electroceramic member has an identical compositional chemistry and grain size diameter that is less than or equal to 50 nm.

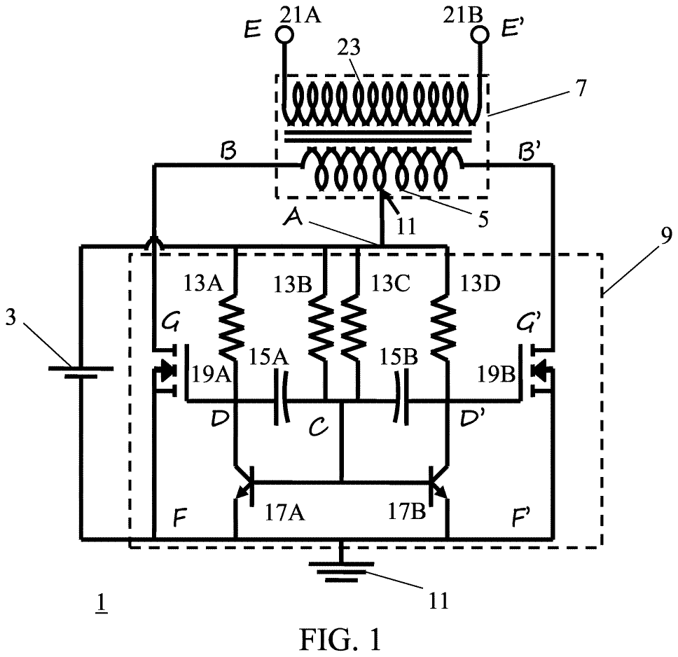

A primary embodiment of the application instructs a fully integrated power inverter 170. FIG. 1 illustrates the schematic of a power inverter circuit 1 that depicts means to transform DC input power into an AC output. Alternative circuit topologies exist to the circuit schematic shown in FIG. 1. The application claims means to fully integrate any power inverter circuit regardless of the circuit's topology. The power inverter circuit 1 comprises a DC power source 3 that is in electrical communication through first conductive means 106 with the primary coil 5 of a transformer 7 and a Wiggler circuit 9 at topological points A and F, F′. Topological point A feeds a center tap 11 of the primary coil 5 of transformer 7 and the input to the Wiggler circuit 9 where it feeds parallel resistors 13A, 13B, 13C, 13D. Parallel resistors 13B and 13C terminate a topological point C, which also is in electrical connection with polarized capacitors 15A, 15B and the gate electrodes of power control transistors 17A, 17B. Parallel resistors 13A and 13D terminate at topological points D, D′, respectively, which also is in electrical connection with polarized capacitors 15A, 15B and the gate electrodes of power FETs 19A, 19B. Topological points D and D′ are also electrically connected to the source electrodes of power control transistors 17A, 17B. The drain electrodes of power control transistors 17A, 17B is in electrical communication with ground 11 and topological points F, F′ that are also in the electrical communication with the source and gate electrodes of power FETs 19A, 19B. The drain electrodes of power FETs 19A, 19B supply topological points G, G′ that supply the Wiggler Circuit's 9 output currents that are input to the transformer's 7 primary coil 5 at topological points B, B′. AC power emerges from output electrodes 21A, 21B′ of the transformer's 7 secondary coil 23 at topological points E, E′.

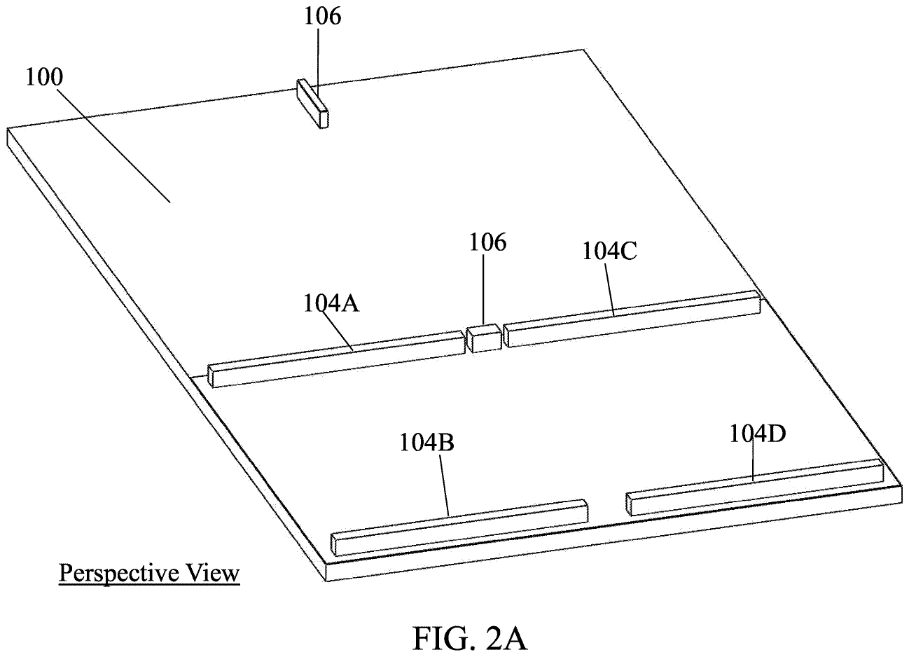

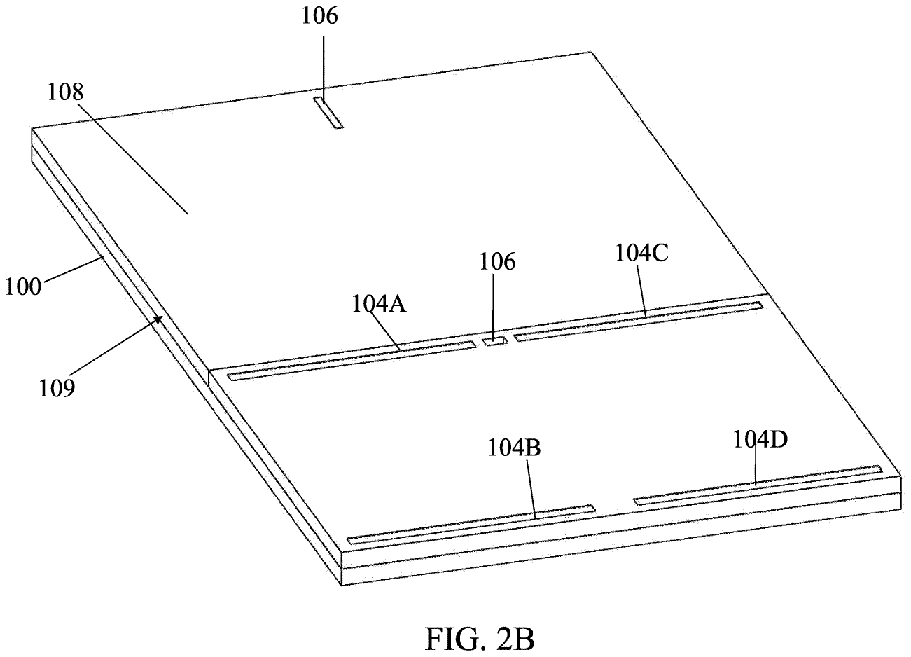

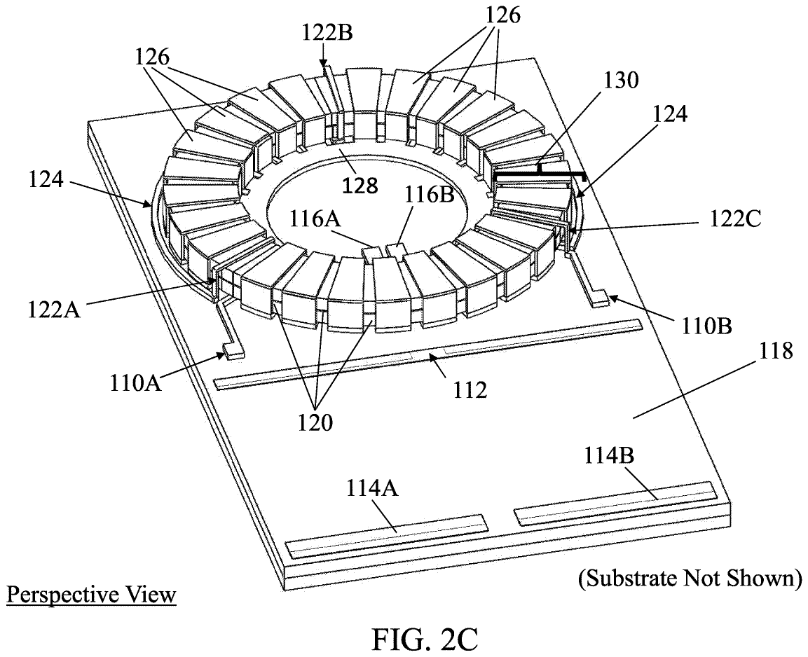

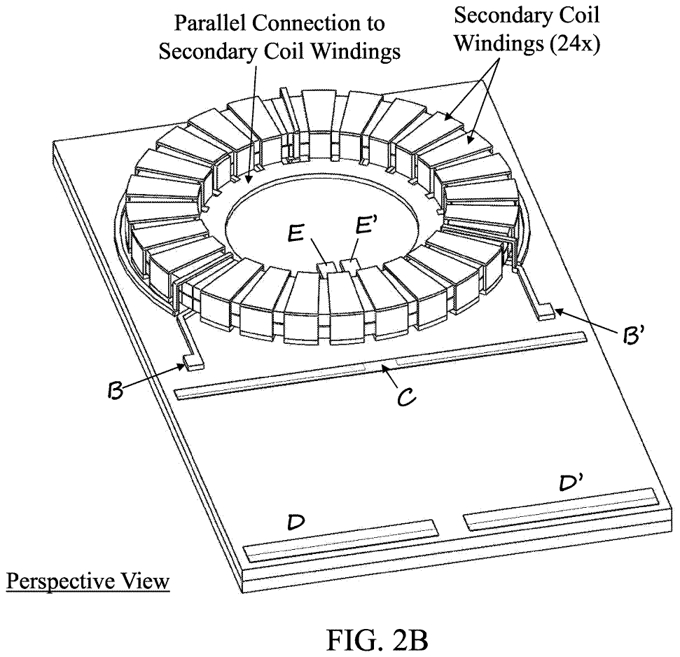

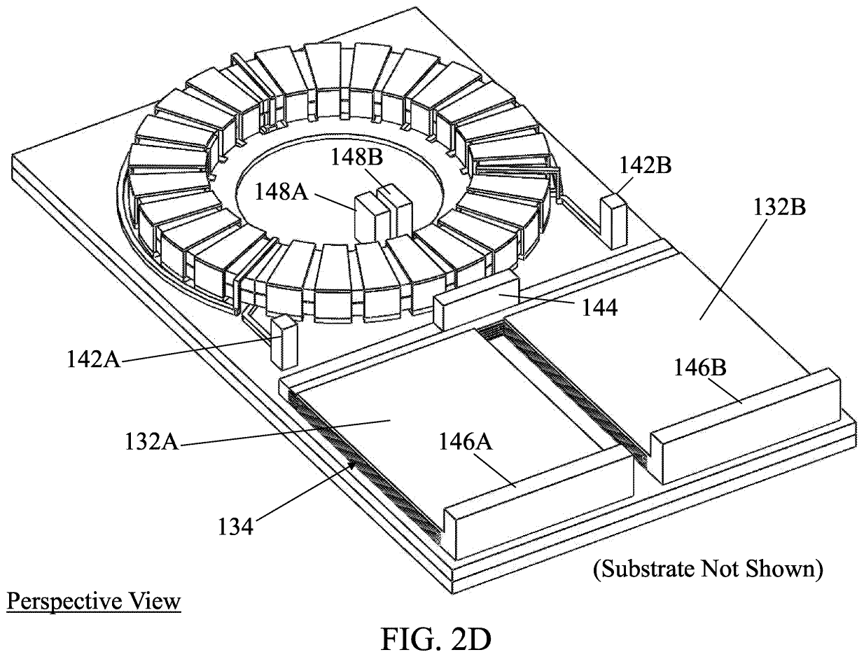

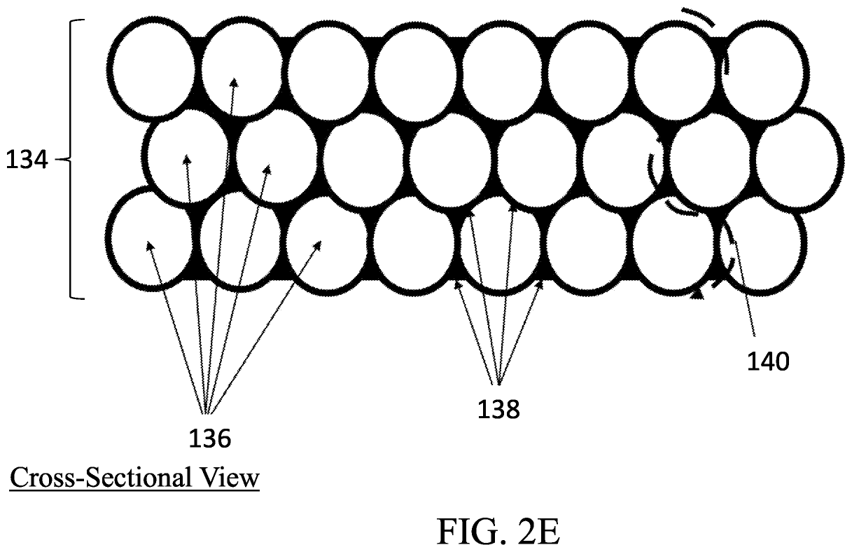

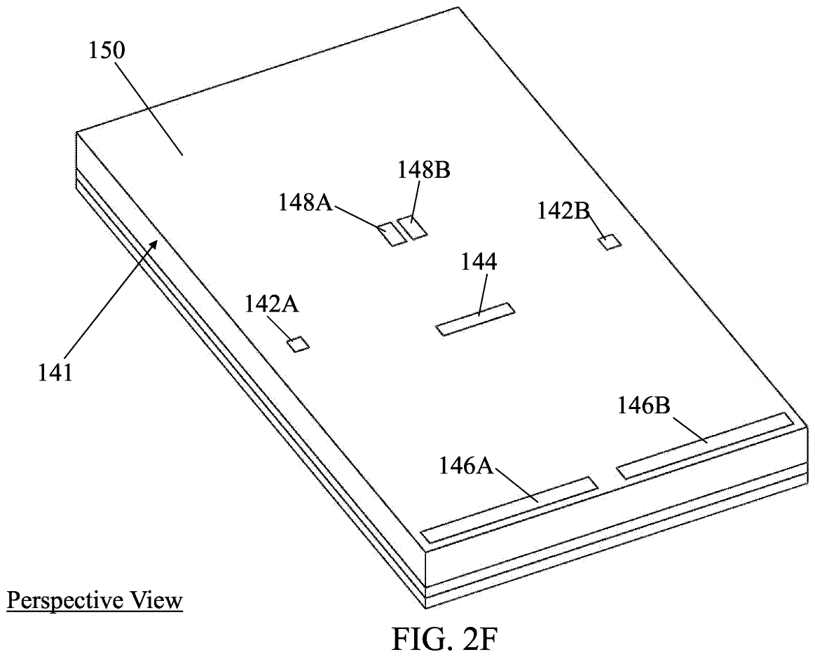

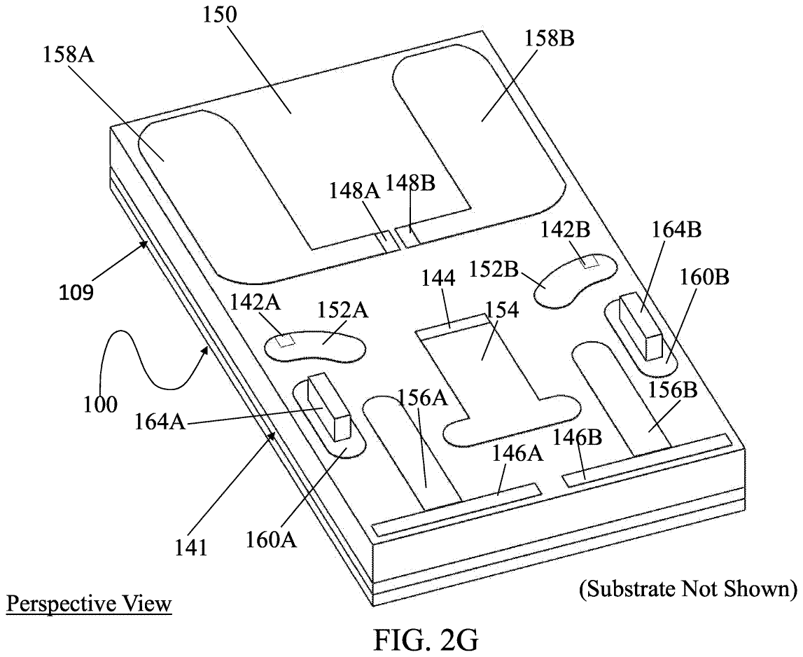

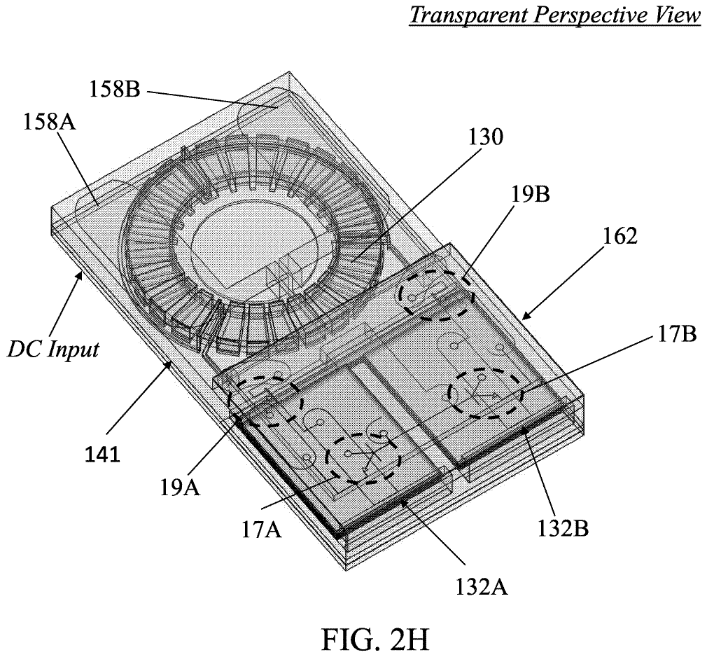

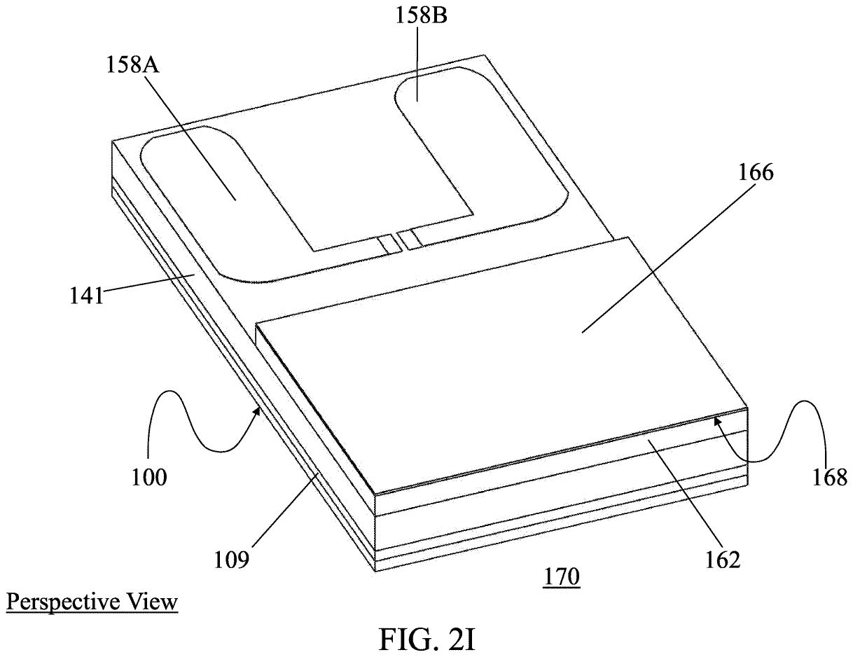

Reference is now made to FIGS. 2A, 2B, 2C, to depict a fully integrated power inverter 170 and the method of its construction. The fully integrated power inverter comprises an input electrode 100 that forms the topological point A in FIG. 1. The input electrode 100 comprises conductive means that may consist of an elemental metal, such as copper, silver, or gold, an alloy or superalloy comprising a plurality of elemental metals, wherein the allow or superalloy further comprises the Big Nano material phase of the alloy or superalloy. The conductive means of input electrode 100, and all electrodes in the fully integrated power inverter 170 may also comprise a conducting ceramic or superconducting ceramic. Preferably, LCD methods are used to optionally form the input electrode 100 on a substrate 102. The substrate 102 may also be a sacrificial substrate that is subsequently removed after the fully integrated power inverter 170 is fully constructed to expose the input electrode as a contact surface.

LCD methods are then used to selectively deposit ceramic oxides that form resistors 104A, 104B, 104C, 104D on the input electrode 100 that serves as topological point A within the fully integrated power inverter 170. Resistive electroceramic compositions are usually classified in terms of their crystal structure and typically contain the following metal oxides as a primary component: copper oxide (CuO), nickel oxide (NiO), ruthenium oxide (RuO₂), irdium oxide (IrO₂), rhodium oxide (Rh₂O₃), osmium oxide (OsO₂), and antimony oxide (Sb₂O₃). This group of primary metal oxides comprises the group of preferred electroceramic compositions. These single component resistive electroceramics adopt a rutile crystal structure, with the exception of antimony oxide (Sb₂O₃) and rhodium oxide (Rh₂O₃), which have a trigonal crystal structures, and copper oxide (CuO) and nickel oxide (NiO), which have a cubic close-packed crystal structure. Intrinsic resistivity of the primary metal oxides with rutile crystal structures can be altered when the rutile primary oxides are combined together and with one or more transition-metal oxides and/or heavy-metal oxides in amounts that crystallize into a pyrochlore crystal structure. Intrinsic resistivity of the primary metal oxides with rutile crystal structures can also be altered when the rutile primary oxides are combined together and with one or more alkaline earth metal oxides and heavy-metal oxides in amounts that crystallize into a perovskite crystal structure. The compositional chemistry of these crystal structures generally adopt the following formulas:

M⁽¹⁾M⁽²⁾₂O₇ (pyrochlore) (1a)

M⁽³⁾M⁽²⁾O₃ (perovskite). (1b)

Where M⁽¹⁾ represents one or more trivalent transition-metal oxides and/or one or more trivalent heavy-metal oxides, M⁽²⁾ represents one or more of the primary metal oxides with rutile crystal structure cited above, and M⁽³⁾ represents one or more alkaline earth metal oxides. Preferred trivalent transition-metal oxides are from the group consisting of: scandium oxide (Sc₂O₃), titanium oxide, (Ti₂O₃), vanadium oxide (V₂O₃), chromium oxide (Cr₂O₃), manganese oxide (Mn₂O₃), iron oxide (Fe₂O₃). Preferred heavy-metal oxides are drawn from the group consisting of bismuth oxide (Bi₂O₃), lanthanum oxide (La₂O₃), cerium oxide (Ce₂O₃), lead oxide (PbO) and neodymium oxide (Nd₂O₃). Preferred alkaline earth metal oxides are drawn from the group consisting of magnesium oxide (MgO), calcium oxide (CaO), strontium oxide (SrO), and barium oxide (BaO).

LCD methods are additionally used to selectively deposit first conductive means 106 that forms the center tap connection 11 to the input electrode 100 at topological point A. An insulating layer 108 is then deposited over the assembled structure to form a first fully integrated layer 109 comprising conductive means 106 for a center tap transformer connection to a ground layer 100 and resistors 104A, 104B, 104C, 104D embedded within an insulating layer 108. Amorphous silica is a preferred material for use as the insulating layer 108 due to its extreme insulating characteristics (high breakdown voltage and ultra-low loss properties). Chemical mechanical polishing methods are then used to planarize the insulating layer 108, that has low loss, preferably ultra-low loss, and can sustain high dielectric breakdown voltage, to expose resistors 104A, 104B, 104C, 104D and the first conductive means 106 that forms the center tap connection 11 as shown in FIG. 2B.

As depicted in FIG. 2C, LCD methods are utilized to selectively deposit second conductive means 110A, 110B, 112, 114A, 114B and 116A, 116B to create the electrical interconnections matching topological points B, B′, C, D. D′ and E, E′, respectively, on the planarized insulating layer 118. It is a preferred embodiment of the application to form a transformer coil 7 that comprises a primary coil 5 and secondary coil 23 having interleaved toroidal windings around an ultra-low loss magnetic core 120. This configuration minimizes proximity, flux leakage losses and electromagnetic interference (EMI) since the magnetic current flows along a closed path. The primary coil 7 comprises electrically conductive means that interconnects primary coil windings 122A, 122B, 122C through a circumferential series interconnection 124 to each other and second conductive means 110A, 110B, wherein the center winding 122B is in electrical communication with conductive means 106 and the input electrode 100. The secondary coil 23 comprises electrically conductive means that interconnects secondary windings 126 through a circumferential parallel interconnection 128 to second conductive means 116A, 116B that form the output of the transformer's 7 secondary coil 23.

The toroidal structure of transformer 7 minimizes electromagnetic interference (EMI) because the magnetic current follows a closed path within the magnetic core 120 of toroidal transformer 130. The parallel secondary windings 126 interleaved between the serial primary coil windings 122A, 122B. 122C also minimizes proximity losses caused by fringing fields to increase the fully integrated power inverter's overall power efficiency. LCD methods are used to fabricate the toroidal transformer 130, either directly on planarized layer 118, or the toroidal transformer 130 may be prefabricated and mounted on planarized layer 118. Likewise, LCD methods may be used to fabricate capacitors 15A, 15B, either directly on planarized layer 118, or the capacitors 132A, 132B (15A, 15B) may be prefabricated and mounted on planarized layer 118 as shown in FIG. 2C.

Capacitors 132A, 132B comprise at least one dielectric member 134 that contains an electroceramic that is in the Big Nano phase, wherein the microstructure of the electroceramic dielectric member 134 further comprises a uniform distribution of grains having the same composition and uniform grain size that is less than or equal to 50 nm. (See FIG. 2D). It is desirable to minimize the size/weight of the fully integrated power inverter 170, so a further embodiment of the application is to use ultra-high energy density capacitors that have average atomic mass units (amu) in excess of 25 amu, preferably in excess of 50 amu, wherein the polarization response is limited to the deformation of atomic orbitals. Internal atomic polarization components are proportional to the number of electrons within the deformed orbital electron cloud and the net positive charges of the exposed nucleus. Since number of orbital electrons and protons contributing positive charge to the atomic nuclei of the rigidly fixed cations and anions directly correspond to their atomic mass unit (amu), it is a preferred embodiment of the present invention to construct storage capacitors 132A, 132B that incorporate high energy density dielectric layers 134. LCD manufacturing methods permit the reliable fabrication of dielectric layers having high chemical complexity comprising three or more metal oxide components. The basic stoichiometry of titanate perovskite electroceramics is given by the formula equation:

M⁽¹⁾_{(1-x-y-z)}M^{(II)}₍ₓ₎M^{(III)}_{(y)}M^{(IV)}_{(z)}Zr_{(1-a-b)}Hf_{(b)}Ti₍ₐ₎O₃ (2)

where M^{(I)}, M^{(II)}, M^{(III)}, M^{(IV)} are additional metal oxide components that form a thermodynamically stable perovskite crystal. The same general relationship applies to niobate and tantalate electroceramics, which are implicitly claimed by the present invention. Higher average amu is achieved by incorporating higher amu elements into the perovskite chemical formula. It is therefore a specific embodiment of the application to claim high energy density dielectric layers 116 that comprise a perovskite electroceramic that includes three or more metal oxide components that further comprise an admixture of three (3) or more of the elements listed in Table I.

TABLE I
Transition Metal Elements

| Symbol | Sc | Ti | V | Cr | Mn | Zn | Y | Zr | Nb | Mo | Hf | Ta | W |
|---|---|---|---|---|---|---|---|---|---|---|---|---|---|
| Average amu | 21 | 22 | 41 | 42 | 25 | 30 | 38 | 40 | 41 | 42 | 72 | 73 | 74 |

Lanthanide Metal Elements

| Symbol | La | Ce | Pr | Nd | Sm | Eu | Gd | Tb | Dy | Ho | Yb |
|---|---|---|---|---|---|---|---|---|---|---|---|
| Average amu | 57 | 58 | 59 | 60 | 62 | 63 | 64 | 65 | 66 | 67 | 70 |

Post Transition Metal Elements

| Symbol | In | Sn | Pb | Bi |
|---|---|---|---|---|
| Average amu | 49 | 50 | 82 | 83 |

Reference is now made to FIG. 2D to illustrate means to minimize dissipation currents that will introduce power loss and short the multilayer storage capacitor, especially when the thickness d of the ultra-high energy density dielectric layer 134 is extremely thin (≤100 nm). Often impurities that are introduced during electroceramic processing will form conductive oxides that are not thermodynamically compatible with the electroceramic crystalline lattice. These conductive metal oxide species will migrate from the electroceramic grain core 136 to the electroceramic grain boundaries 138 during processing and form conductive pathways 140 that generate dissipation currents and power loss. Therefore, a particular aspect of the invention dopes the electroceramic composition described by equation (2) with small amounts of silicon dioxide (SiO₂) that will migrate from the grain core 136 and into the grain boundaries 138 to form highly electrically insulating metal oxide phases with the grain core material that resist dissipation currents and neutralize the formation of conductive pathways 140.

Reference is now made to FIG. 2E to form a second fully integrated layer 141 comprising vertical vias 142A, 142B, 144, 146A, 146B, 148A, 148B, a toroidal transformer 130, and capacitors 132A, 132B embedded in a planarized insulating layer 150. LCD methods are then used comprising selectively deposit conductive means to form vertical vias 142A, 142B, 144, 146A, 146B, 148A, 148B. Vertical vias 142A, 142B provide conductive means to topological points B, B′ respectively, on a superior layer of the fully integrated power inverter 170. Likewise, vertical vias 144, 146A, 146B and 148A, 148B provide conductive means to topological points C, D, D′ and E, E′, respectively, on a superior layer of the fully integrated power inverter 170. A planarized insulating layer 150, (shown in FIG. 2E), preferably comprising amorphous silica dielectric is added to the assembly on top of the vertical vias and chemical mechanical polishing methods are used to expose conductive means forming vertical vias 142A, 142B, 144, 146A, 146B, 148A, 148B on a superior surface of the planarized insulating layer 150 of the fully integrated power inverter 170.

FIG. 2F, 2G, 2H, 2I depict conductive means 152A, 152B, 154, 156A, 156B, 158A, 158B, 160A and 160B, preferably, but not necessarily, formed using LCD methods, are selectively deposited on the planarized insulating layer 150 to place the passive components embedded in the first and second fully integrated layers 109 and 141 in electrical communication with the active circuitry 162 of the fully integrated power inverter 170. Conductive means 152A, 152B creates an electrical interface with the primary coil 5 (122A, 122B, 122C) of transformer 7 (130) through vertical vias 142A, 142B at topological points B, B′, which are in simultaneous electrical communication with ports to the drain electrodes of power FETs 19A, 19B embedded within active circuitry 162. Conductive means 152A, 152B also provides electrical communication between topological points G and B, and G′ to B′ respectively. Conductive means 154 creates an electrical interface with ports to the gate electrodes of power control transistors 17A, 17B, in active circuitry 162 and vertical via 144 that forms an electrical interface with resistors 13A, 13B (104A, 104B) and capacitors 15A, 15B (132A, 132B) at topological point C. Conductive means 156A, 156B creates electrical interfaces with ports to the gate electrodes in power FETs 19A, 19B and the source electrodes of power control transistors 17A, 17B in active circuitry 162 to resistors 13A, 13D (104B, 104D) and capacitors 15A, 15B (132A, 132B) at topological points D, D′. Conductive means 158A, 158B creates electrical interfaces with ports to the drain electrodes or power control transistors 17A, 17B and the source electrodes of power FETs 19A, 19B in active circuitry 162 to provide electrical communication at topological points F, F′. LCD methods are used to form vertical vias 164A, 164B that place conductive means 160A, 160B in electrical communication with a ground plane 166 on the superior surface of active circuitry 162 in the Wiggler Circuit 9 or upon a final planarized insulating layer 168 as may be needed when discrete active elements are assembled into the Wiggler Circuit 9.

Active circuitry comprises power control transistors 17A, 17B and power FETs 19A, 19B either as a singular fully integrated chip comprising all the transistor elements or as discrete components mounted on the conductive means 152A, 152B, 154, 156A, 156B, 160A and 160B upon which a final planarized insulating layer 168 is optionally formed. It is a preferred embodiment of the application that power control transistors 17A, 17B and, especially, power FETs 19A, 19B comprise resonant gate transistor to minimize On-Resistance of the transistor elements and maximize switching speed to optimize the efficiency of the fully integrated power inverter 170.

FIG. 2H illustrates the final embodiment of a fully integrated power inverter 170, which consists of an input electrode 100 that connects the fully integrated power inverter 170 to its DC input 3. A first fully integrated layer 109 comprising resistive elements 104A, 104B, 104C, 104D and embedded in an insulating layer 108 places the DC input 3 in electrical communication with conductive means 112 that electrically connects the resistive elements 104A, 104B, 104C, 104D to the capacitors 132A, 132B. The first fully integrated layer 109 further comprises conductive means 106 that places the DC input 3 in electrical communication with the center tap winding 122B of a primary coil 5 that is wound in series within a toroidal transformer 130. A second fully integrated layer 141 embeds the toroidal transformer 130 and capacitors 132A, 132B within a planarized insulating layer 150. The second fully integrated layer 141 further comprises conductive means 142A, 142B, 144, 146A, 146B, 148A, 148B that provide vertical electrical communication between the primary coil 5 of the toroidal transformer 130, the resistive elements 104A, 104B, 104C, 104D, and the capacitors 132A, 132B to appropriate ports of the active circuitry 162 of the Wiggler Circuit 9. The active circuitry 162 comprises power control transistors 17A, 17B and power FETs 19A, 19B, which may be integral to a single chip or discretely assembled into the Wiggler Circuit 9 of the fully integrated power inverter 170 and embedded within the final planarized insulating layer 168. A ground plane 166 that is in electrical communication with conductive means 164A, 164B and there through to ports in the active circuitry 162 that make appropriate electrical connection between the ground plane 166 and power control transistor 17A, 17B and power FETs 19A, 19B at topological points C, C′, D, D′, F, F′. Conductive means 158A, 158B form the AC output through their electrical communication with the parallel windings 126 of the secondary coil 23 in toroidal transformer 130 at topological points E, E′ and conductive means 116A, 116B, 148A, 148B.

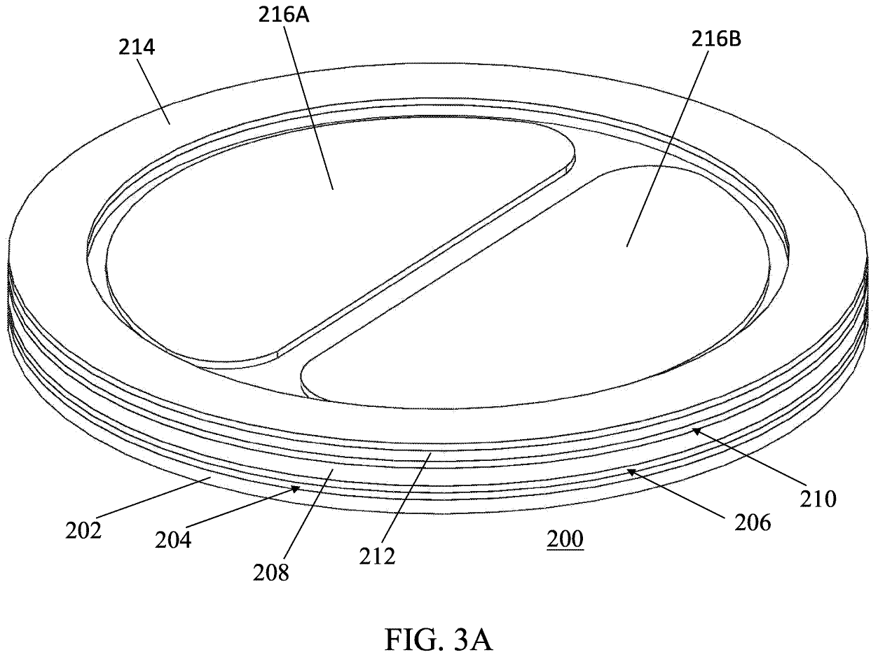

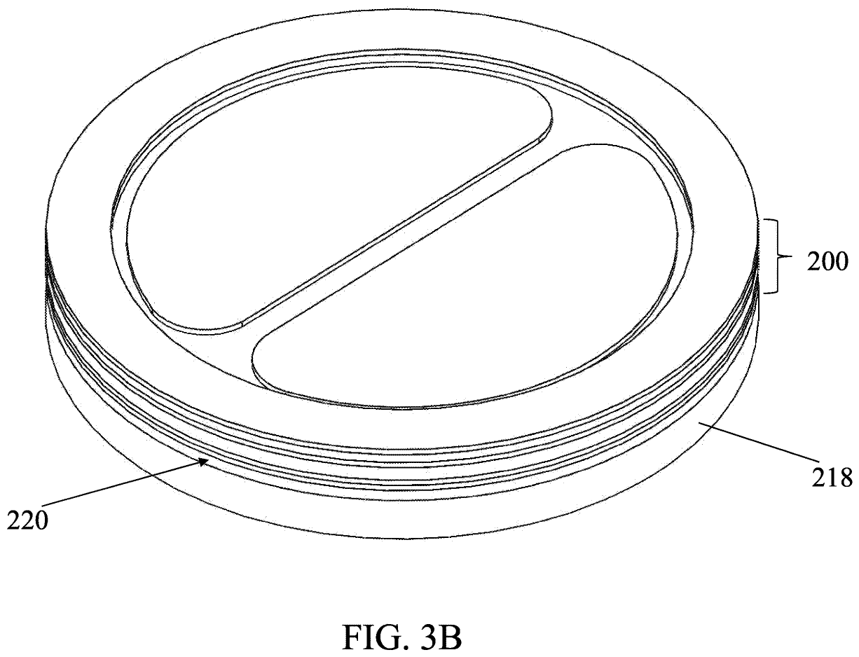

FIGS. 3A, 3B illustrate an additional preferred embodiment that applies to high power applications wherein the fully integrated power inverter 200 is an assembly of at least 6 inch (150 mm) circular wafers. This fully integrated power inverter 200 comprises a DC input electrode 202, a first fully integrated layer 204 comprising resistors 13A, 13B, 13C, 13D and conductive means 11 that makes a center tap connection to at least one primary coil 5 of the transformer 7 that are embedded in the first planarized insulating layer 206 with vertical conductive means to the second fully integrated layer 208. The second fully integrated insulating layer 208 embeds at least one transformer 7 that further comprises a primary coil 5 wound in series 122A, 122B. 122C around a magnetic core 120, wherein the at least one transformer 7 additionally comprises a secondary coil 23 consists of parallel windings 126. The magnetic core 120 may comprise a magnetic ceramic compound, but it is a preferred embodiment of this application that the magnetic core 120 consist of composite ferromagnetic core comprising metallic ferromagnetic material as shown below.

In this embodiment of the fully integrated power inverter 200 a plurality of transformers 7 and Wiggler circuit 9 may be configured to operate in parallel or in phased sequence with one another as described below. The second fully integrated layer 208 further comprises at least two capacitors 15A, 15B depending upon the number of Wiggler Circuits 9 that are integrated into the fully integrated power inverter 200 as well as conductive means 110A, 110B, 112, 114A, 114B, 142A, 142B, 144, 146A, 146B that electrically connect the Wiggler Circuit(s) 9 at topological surface points A, B, B′, C, D, D′, E, E′, F, F′, G, G′. A final planarized insulating layer 210 comprises conductive means that ensure electrical communication to ports on a semiconductor wafer having active circuitry 212. Semiconductor wafer having active circuitry 212 power control transistors 17A, 17B and power FETs 19A, 19B, as well as conductive means that function as ports that electrically complete the Wiggler Circuit(s) 9. It is a preferred embodiment of the application to incorporate resonant gate transistors in the power control transistors 17A, 17B and power FETs 19A, 19B. A ground plane 214 and AC Output electrodes 216A, 216B complete the construction of the fully integrated high power fully integrated power inverter 200. As depicted in FIG. 3B. an additional embodiment of the invention attaches a resonant energy storage device 218 to the input electrode 202 of the high power fully in the high power fully integrated power inverter 200. The resonant energy storage device 218 is a high energy storage capacitor with inductive loads integrated into the capacitor input and output electrodes to tune the charge and discharge rates to optimize the supply of energy to a high power system.

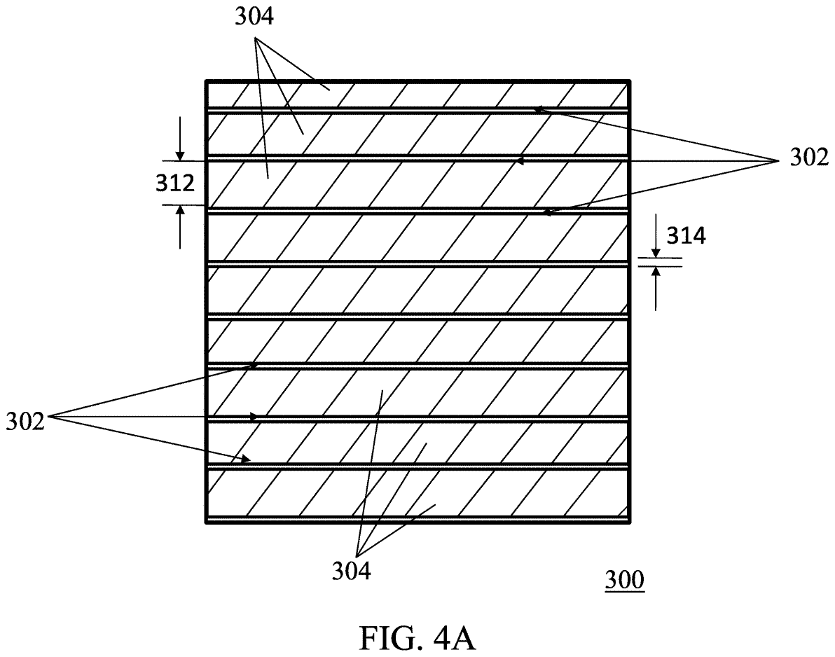

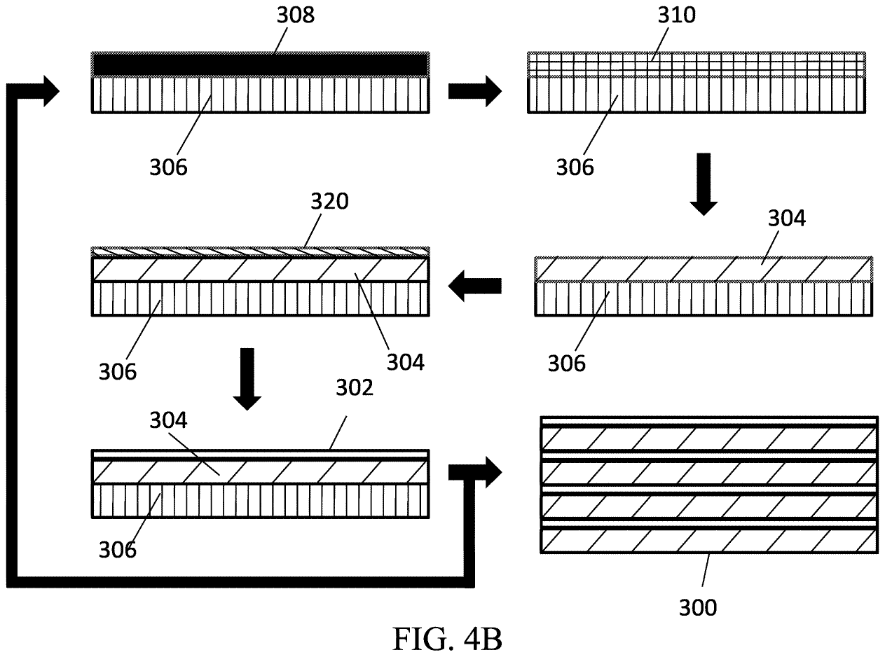

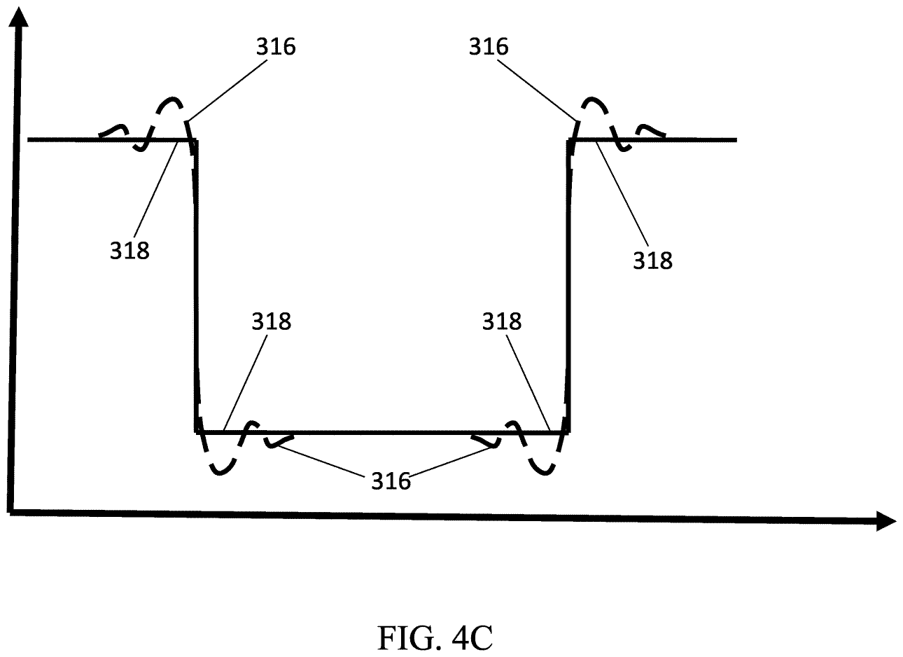

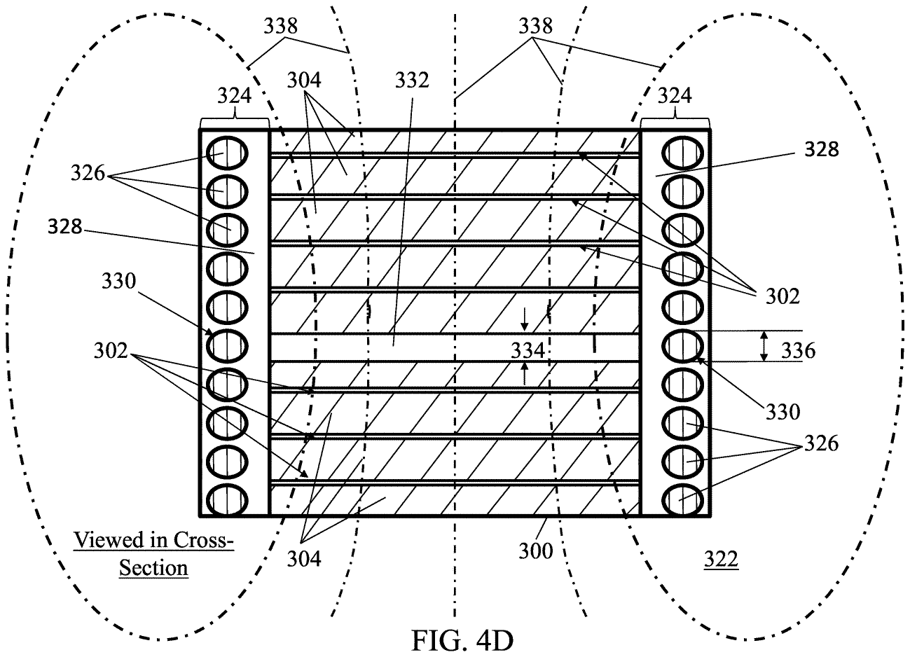

Reference is now made to FIGS. 4A, 4B, 4C, 4D illustrate other embodiments of the invention relating to magnetic cores 120, in particular composite ferromagnetic cores 300 used in magnetic circuits that relate to fully integrated power inverters, DC electric motors and other applications. Magnetic cores with high relative magnetic permeability, μᵣ, are desirable in electromagnet applications because of their ability to generate higher linkage flux densities, di, that perform the work in electrical motor drives. Since it is desirable to lighten the weight of these systems, magnetic cores with maximal magnetic permeability (μᵣ) are desirable for their ability maximize linkage flux densities, φ₁. However, as depicted in Table II, the materials with the highest initial magnetic permeability (Mumetal® and Supermalloy) have very low resistivity (60 μΩ-cm⁻¹) and their permeability is reduced by 35% at very modest AC frequencies (60 Hz). This low resistivity makes ferromagnetic metallic cores susceptible to high Eddy current losses when modulated or switched at low and especially high AC frequencies, where they have severely reduced permeability. High magnetic permeability at high power switching or modulation speeds are desirable in magnetic circuit engineering, because component size, weight and loss varies inversely with switching frequencies. Resonant gate transistors were designed to switch arbitrarily high currents and arbitrarily high switching speeds with minimal junction resistance, power loss, and heat generation. Since it is an object of the invention to use resonant gate transistors in the power control transistors 17A, 17B, and power FETs 19A, 19B so the fully integrated power inverter 200 can be driven at high speeds (frequencies >1 MHz), it is a further objective of the invention to utilize an ultra-low loss high permeability composite ultra-low loss ferromagnetic core 300 in the electromagnet, transformer, and permanent magnet components in the fully integrated power inverter 200 and electric motor 400 embodiments.

TABLE II

| | μᵣ (DC) | μᵣ (AC @ 60 Hz) | ρ (μΩ-cm) (DC) |
|---|---|---|---|
| Mumetals ® | | | |
| (Fe₁₇Ni₅₆Cu₅Cr₂) | | | |
| 80% Nickel Alloy | >400,000 | — | 60 |
| 49% Nickel Alloy | 100,000 | 65,000 | 60 |
| Iron Alloys | 5,000 | — | 60 |
| Supermalloy | | | |
| (Ni•Fe•Mo) | | | |
| | 800,000 | — | 60 |

Metallic ferromagnetic cores are electrically conductive and have low electrical resistivity that allows Eddy currents to form back electromotive forces (EMF) that reduce the effective permeability of the metallic magnetic core by reducing the strength of the induced field. Therefore, it is desirable to develop integral composite bodies that high permeability approaching metallic ferromagnetic cores values with higher resistivity that reduce Eddy current losses.

FIG. 4A depicts a composite ferromagnetic core 300 with integral layers of extreme resistivity amorphous silica 302 (ρ=10¹⁸ Ω-cm) embedded within metallic magnetic core elements 304. LCD methods are used to form metallic magnetic core elements 304 and layers of extreme resistivity amorphous silica 302. FIG. 4B depicts the method by which the composite ultra-low loss ferromagnetic core 300 is produced. The metallic magnetic core elements 304 are formed initially by spraying nonvolatile liquid metalorganic acid salts on a heated substrate 306 to form an organic laden glassy metal solid solution with atomic scale chemical uniformity 308. The substrate 306 is preferably a sacrificial substrate when a free-standing composite ultra-low loss ferromagnetic core 300 is desired. Alternatively, the substrate 306 may be a structural element of the desired magnetic system wherein the substrate 306 may be magnetic or magnetically inert.

LCD methods are used to form an initial organic laden glassy metal solid solution with atomic scale chemical uniformity 308 on the substrate 306 in reducing atmospheres comprising helium (He), nitrogen, (N₂), hydrogen (H₂), and ratios of carbon monoxide (CO) and carbon dioxide (CO₂) or any mixture thereof. The substrate 306 is heated to temperatures ranging between 250 °C and 375 °C to simultaneously decompose the nonvolatile metalorganic salts in liquid solution. The organic laden glassy metal solid solution with atomic scale chemical uniformity 308 initially has carbon residue from incomplete combustion (deflagration) of the nonvolatile metalorganic acid salts. The carbon reside is removed by a heat treatment at 450 °C in an argon or substantially argon atmosphere mixed with helium (He), nitrogen, (N₂), hydrogen (H₂), and ratios of carbon monoxide (CO) and carbon dioxide (CO₂) to form a heated treated glassy metal 310. The heat treated glassy metal 310 is then transformed into a metallic magnetic core element 304 by transferring the body from the spray deposition chamber into a plasma annealing chamber while maintaining the reducing atmosphere cited above. The deposited material is then annealed using a plasma power ranging between 250 to 500 Watts. The plasma atmosphere may comprise helium (He), argon (Ar), nitrogen, (N₂), hydrogen (H₂), and ratios of carbon monoxide (CO) and carbon dioxide (CO₂) or any mixture thereof. The substrate temperature is set to 150 °C to 500 °C in the plasma annealing chamber and the metallic magnetic core element 304 is annealed for a time ranging between 10 seconds and 10 minutes. The annealing process is stopped after the polycrystalline grains in the metallic magnetic core element 304 evolve to a matrix of uniformly sized grain having identical chemical composition and physical diameter ranging between 5-7 μm to minimize residual loss within the metallic magnetic core element 304. The atomic scale chemical uniformity in the glassy metal solid solution 308 assures uniform chemical kinetics and uniform grain growth rates throughout the heat treated glassy metal 310 so a metallic magnetic element is produced with theoretical density, precise composition and uniform grain structure to maximize permeability of the layer. Magnetic fields are applied during processing when it is desired to produce metallic magnetic core elements 304 that function as permanent magnets.

Residual loss, which becomes prolific at higher frequencies, is caused when multiple lines of flux become entangled within the same polycrystalline grain. Grain size less 7 μm minimize residual loss, so the plasma annealing step is limited to applied powers and exposure times that restrict grain size within metallic magnetic core element 304 to ≤7 μm. The thickness 312 of the metallic ferromagnetic core element 304 layer is ideally formed to range between 5 μm and 5 mm, though it may have any lesser or greater thickness to meet a design objective. The compositions of the metallic magnetic core element 304 are as depicted in Table III for specific applications. Electromagnet applications favor metallic magnetic core elements 304 having high initial permeability, higher electrical resistance, and lower magnetic coercivity. Permanent magnet application favor metallic magnetic core elements 304 having high saturation fields, higher electrical resistance and high magnetic coercivity. Additives may be added to increase these characteristics over the core alloy compound or added to improve the operational temperatures in which the metallic magnetic core elements 304 can operate.

TABLE III
Preferred Elemental Compositions of
Metallic Magnetic Core Elements

| Core Alloy Elements | Alloying Additives |
|---|---|
| Electromagnet Applications | |
| Fe Ni Mn | Cu, Cr, Mo, Zn, Si, Co, P, B, Ta, Nb, Zr |
| Permanent Magnet | |
| Applications | |
| Nd Fe B | Tr, Dy, Ni, Mn |
| Sm Co | Fe, Cu, Zr, Sr, Al, Ni, Co, Mn |

Higher resistivity in the composite ultra-low loss ferromagnetic core 300 is achieved by forming a layer of extreme resistivity amorphous silica 302 on top of the metallic magnetic core element 304. The initial permeability of the composite ultra-low loss ferromagnetic core 300 is reduced by the volume fraction of extreme resistivity amorphous silica 302 embedded into the composite ferromagnetic core 300. Therefore, it is desirable to minimize the layer thickness and number of layers embedded into the composite ferromagnetic core 300. However, the number of layers and layer thickness 314 of the extreme resistivity amorphous silica 302 layer embedded into the composite ferromagnetic core 300 also reduce eddy current loss within the structure. As depicted in FIG. 4C, Eddy current losses create ripple 316 that deviate from the desired switched mode signals 318. The Eddy current induced ripples 316 reduce the overall efficiency in the electromagnetic circuit, so therefore it is desired to maintain Eddy current losses at a minimum.

The layer thickness 314 of the extreme resistivity amorphous silica 302 layer may vary from 1 nm to 100 nm, preferably from 20 nm to 50 nm. Ideally, the composite ferromagnetic core 300 comprising extreme resistivity amorphous silica 302 layers that have a loss tangent in the range of tan δ=10⁻⁴ to 10⁻⁵, resistivity ρ≈10¹⁸ Ω-cm, and dielectric breakdown voltage on the order of 10 MegaVolts-cm-1 or 1,000 V-μm is engineered such that the composite ferromagnetic core 300 has an effective resistivity that are equivalent to ferrite oxide ceramics that typically have high electrical resistivity (ρ≈10³−10⁴ Ω-cm⁻¹). These embedded extreme resistance amorphous silica 302 layers greatly reduced Eddy current losses. Ferrite oxide ceramics have greatly reduced initial permeability in the range of μᵣ=100-500, rather than the extreme permeability of the ferromagnetic metals that can range between μᵣ=100,000 to 1,000,000. The very low electrical resistivity (10⁻⁵ Ω-cm) of the ferromagnetic metals limit their utility in many commercial applications. The principal engineering objective for the composite ferromagnetic core 300 is to produce an integral solid state magnetic body that has an effective permeability greater than μᵣ>1,000, preferably μᵣ>50,000 that are 2 factors to 2 orders of magnitude higher than ferrite oxides, but simultaneously comprise a high effective electrical resistivity equivalent to ferrite oxide ceramics (ρ≈10³−10⁴ Ω-cm⁻¹), which are 8-9 orders of magnitude higher than ferromagnetic metals.

The integral body of the composite ferromagnetic core 300 is made using LCD methods to initially form an organic laden glassy amorphous silica solid solution 320 to the desired layer thickness 314 on top of a metallic ferromagnetic element 304. The organic laden glass amorphous silica solid solution 320 is then heat treated to a temperature of 450 °C to remove the organic residue from the organic laden glass amorphous solid solution 320 to produce the amorphous silica layer 302. The LCD process is then subsequently cycled through process steps shown in FIG. 4B to add additional metallic magnetic core elements 304 having desired thickness 312 and amorphous silica layers 302 having desired thickness 314 until the desired composite ferroelectric core 300 is created. An integral solid state free-standing body formed after the sacrificial substrate 306 is removed. Or, a composite structure is deposited on a substrate 306 that is integral to a component of an inductor, transformer, fully integrated power inverter or other power management circuit, or electric motor. The composite ferromagnetic core 300 may take any shape needed to serve its end-use.

FIG. 4D depicts another embodiment of the invention that comprises an electromagnet 322 that comprises coil windings 324 further comprising conductive means 326 wrapped around a composite ferromagnetic core 300. The electromagnet 322 may be used as an inductor element 5 (23), a transformer element 7, or an element of an electric motor 400 or other electromagnetic system. Conductive means 326 may be insulated from the metallic ferromagnetic elements 304 and adjacent conductive means 326 by amorphous silica insulator 328 to reduce electrical discharges between those elements when high voltages are applied to the electromagnet 322.

A further embodiment strengthens the coupling between a strong coupling coil winding 330 and the magnetic current generated within a composite ferromagnetic core 300. The strong coupling coil winding 330 may be an element of an electrical sensor, the output feed on a high sensitivity magnetic pick up, the winding of primary coil 5 of a transformer 7 or an electromagnet used in an electric motor or power generator. Higher energetic coupling between the magnetic currents in composite ferromagnetic core 300 and the strong coupling coil winding is achieved when an extreme resistance (ultra-low electrical loss) and non-magnetic (μᵣ=1) amorphous silica integral body member 332 is adjacent to the strong coupling coil winding 330. Energetic coupling is optimized when forming the amorphous silica integral body member 332 to have thickness 334 that substantially matches the width/diameter 336 of the strong coupling coil winding 330 and when the major plane of amorphous silica integral body member 332 is oriented perpendicular to the induced or applied magnetic field lines 338 within the composite ferromagnetic core 300.

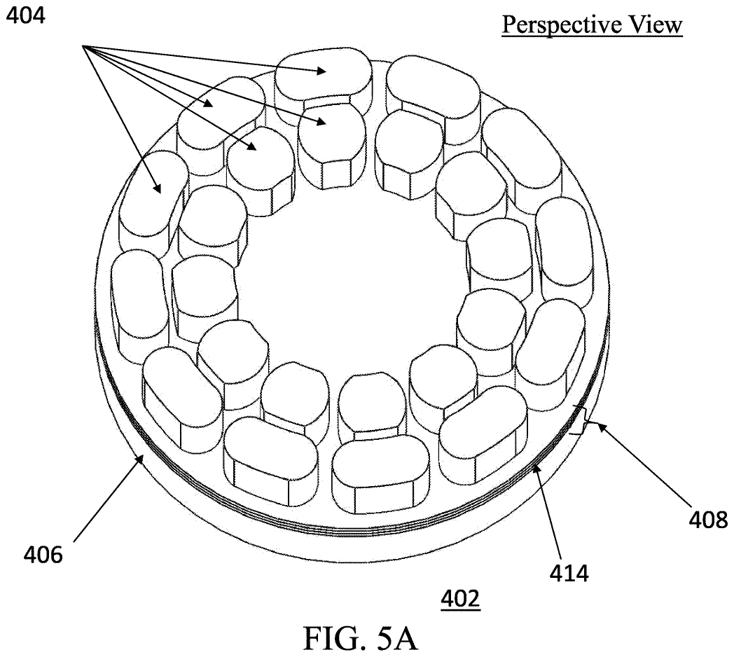

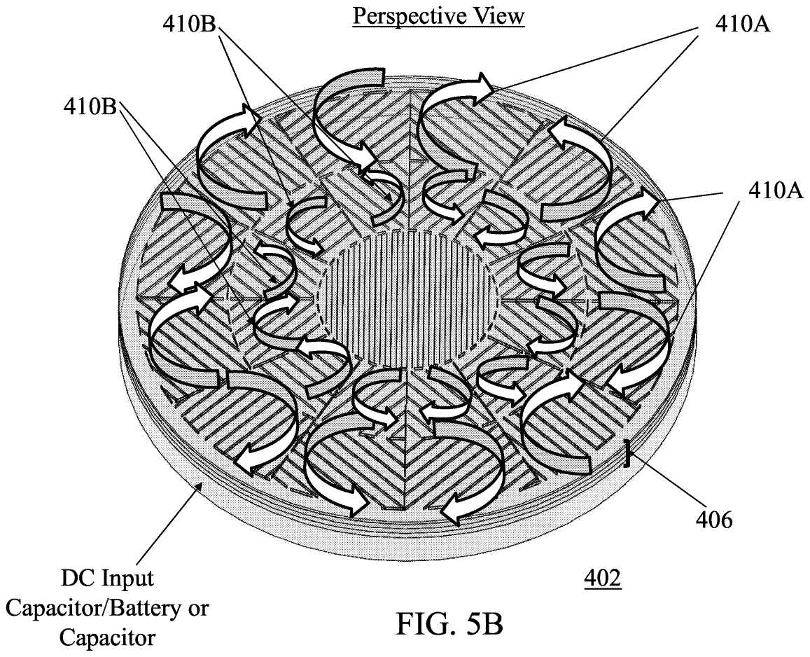

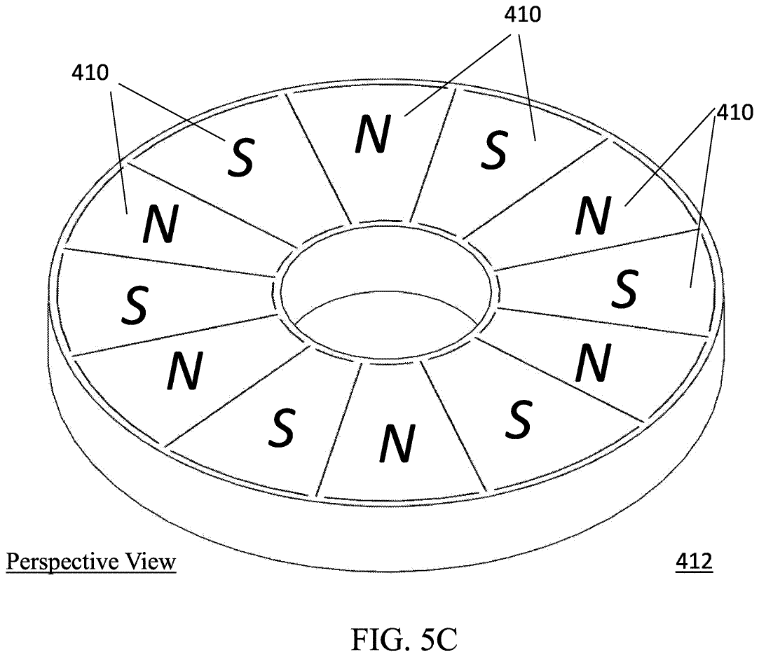

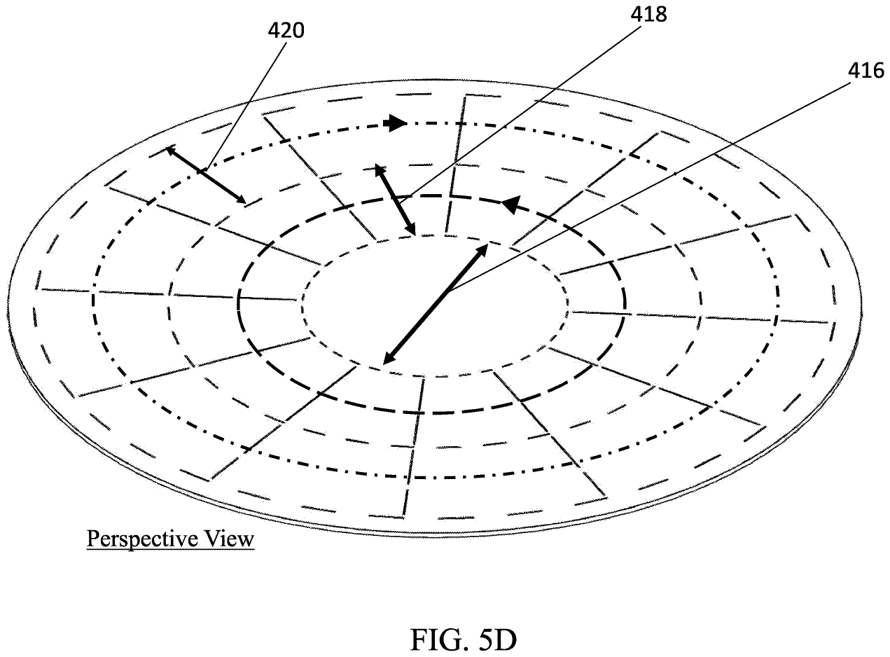

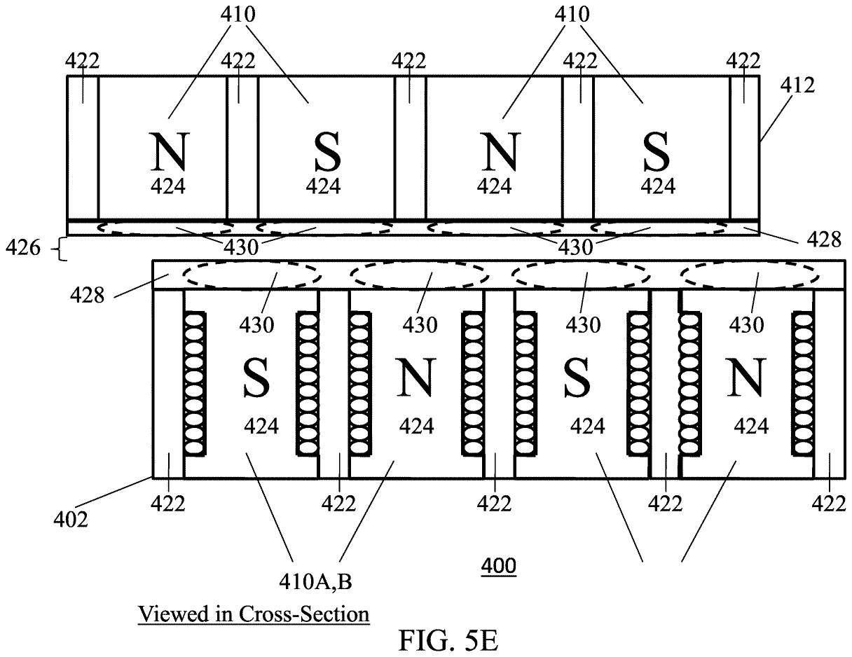

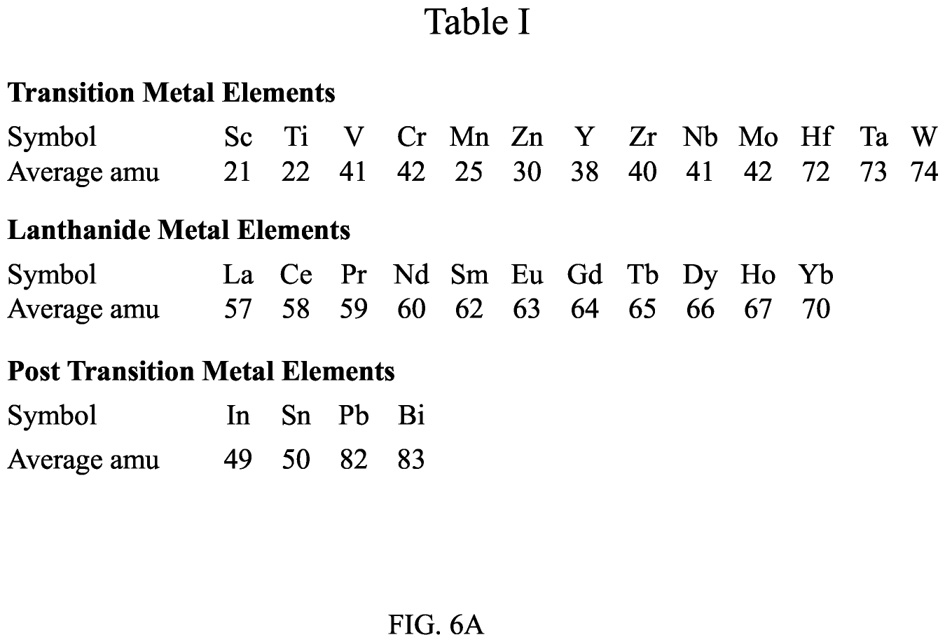

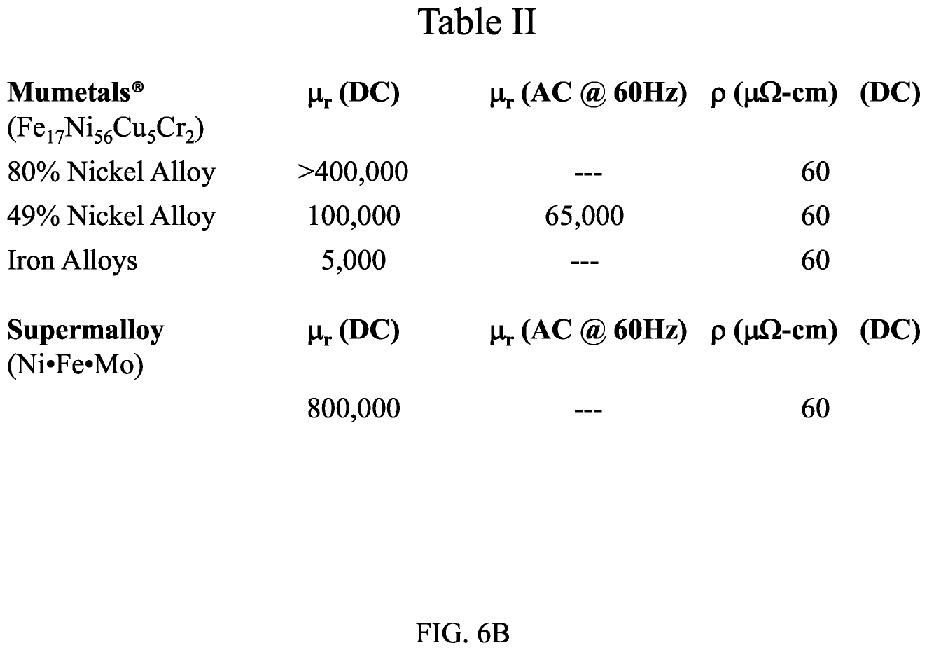

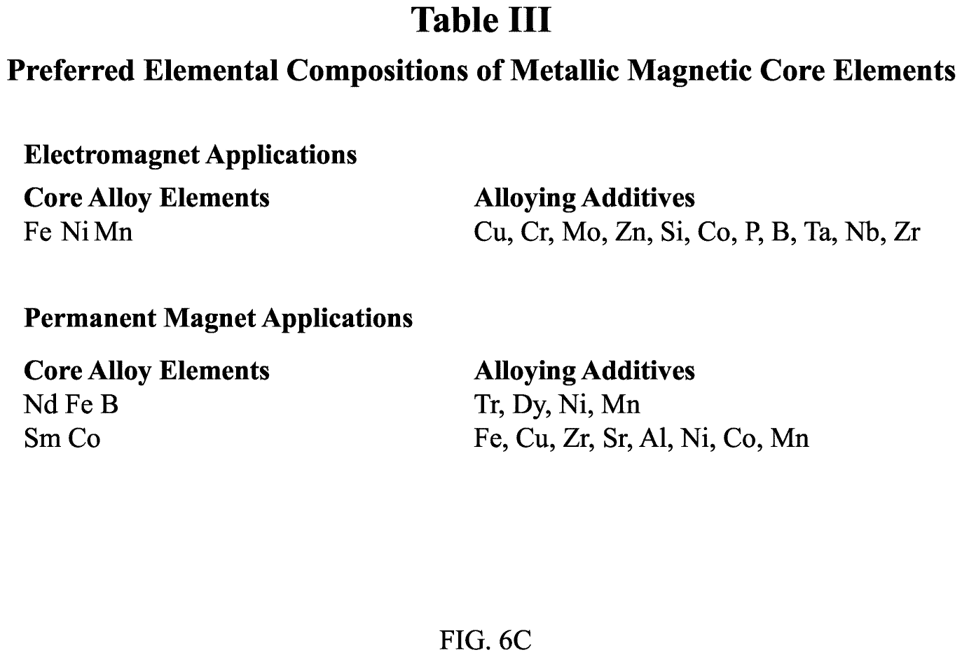

Reference is now made to FIGS. 5A, 5B, 5C, 5D to depict embodiments relating to electrical powered motors 400. Improved electrical efficiency, and reductions in size, weight and part counts are key objectives for extending the range and lowering the cost of electrical motors used in electric vehicles. The filtering characteristics of the gate electrode determine the transconductance of a transistor. The electrode of field-effect transistors (FETs) functions as a capacitor, so transconductance of a power FET matches that of a low-pass filter. Higher frequency operation is achieved by making the size (areal footprint) of the gate electrode smaller. However, this approach greatly increases junction resistance which adds high thermal loads in switched power components like power inverters and other power management devices. Since thermal management systems contribute to added weight and parts count, means to minimize or eliminate those contributions contribute new value to electric motor markets.

Resonant gate transistors embed inductance within the gate electrode so their filtering characteristics are determined by the passive network forming the electrode transmission line. Resonant gate transistors allow very wide transmission lines to be designed. Since the channel resistance component of a FET's On-Resistance (RON) is directly proportional to the ratio of the gate length to the gate width (L_{gate}/W_{gate}) and inversely proportional to the gate capacitance (C_{gate}), resonant gate transistors are designed to minimize (L_{gate}/W_{gate}) and maximize C_{gate}. As a result, transistor RON can effectively be reduced that of the conducting elements in the power transistor structure, thereby minimizing or eliminating thermal management systems from the electric motor 400 and power supply system or power drive unit 402.

High switching speed is an additional benefit of using resonant gate transistors as the switching elements within an electric motor or power management device used in system the electric motor serves. The gate electrode can be designed to resonate at high frequencies when the gate electrode's filtering characteristics enable the resonant gate transistor to modulate currents flowing beneath the transistor electrode at those desired high frequencies. As a result, arbitrarily large currents can be modulated at arbitrarily high speeds with minimal thermal loads. Higher switching speeds reduce the reactance needed for passive components (capacitors, inductors, and transformers) that are used store electrical and magnetic energy within the system. Higher switching speeds reduce the switching loss

P_{Loss}=ΔIR (2)

Since smaller currents (ΔI) are incrementally switched through the system over smaller time intervals, the size of the components though which the currents are switched through are smaller and therefore have lower resistance (R) values, thus increasing the system's electrical efficiency.

Electromagnets 322 comprising composite ferromagnetic cores 300 containing extreme resistivity amorphous silica 302 layers embedded within metallic ferromagnetic elements 304 will have higher permeability and thus generate higher linkage flux, di, that performs the magneto-mechanical work that drives the motor. Higher linkage flux densities will enable smaller electromagnets 322 to be deployed to produce a unit of work. The lower Eddy current losses in electromagnets 322 comprising composite ferromagnetic cores 300 additionally improve electrical efficiency of the electric motor 400.

Similarly, capacitors comprising incorporate high energy density dielectric layers 134, preferably with having average atomic mass unit (amu) values in excess of 25 amu and amorphous silica grain boundaries, minimize capacitor size physical and metallization to reduce loss. It is preferable for high energy density dielectric layers to have thickness 134 less than 100 nm, preferably in the range from 25 nm to 50 nm, to further reduce the capacitive footprint and reduce the size and weight of the electric motor 400. It is a primary objective of this invention to produce a light weight, high efficiency electric motor 400 that regulates in excess of 600 Newton-meters of torque and 250 Kilo-Watts of mechanical power.

As depicted in FIG. 5A, the electric motor 400 comprises a power drive unit operates as the motor stator 402 that consists of an electromagnet array 404. The motor stator 402 may optionally make electrical contact with a resonant energy storage device 406 at the input electrode 100 to fully integrated power inverters 200 associated with each electromagnet 322 in the array 404. Fully integrated power inverters 200 are embedded within a plurality of layers 408 in the motor stator. The electromagnets in the array 404 comprise composite ferromagnetic cores 300 that further comprise metallic ferromagnetic elements 304 in which extreme resistivity amorphous silica layers 302 are embedded, wherein conductive means 326 is used to form the coil winding 324 and amorphous silica insulator 328 is used to insulate conductive means 326 and metallic ferromagnetic elements 304 from one another. The electromagnets 322 in the array 404 may further comprise at least one strong coupling winding 330 within the coil 324 that is adjacent to, and substantially matched in size with, at least one integral amorphous silica member 332 within the composite ferromagnetic core 300. The electromagnets 322 within the array 404 are also constructed such that the major surfaces of extreme resistivity amorphous silica layers 302 and integral amorphous silica members 332 are oriented perpendicular to the induced magnetic field lines 338.

The motor stator 402 comprises a plurality of layers 408 that additionally comprise integrated active circuitry 414 to control the motor 425 that is embedded within the plurality of layers 408. The plurality of layers 408 comprise an input electrode 100, a fully integrated power inverter 200 for each electromagnet in the array 404, wherein the active circuitry 212 in the power drive unit in the motor stator 402 additionally comprises resonant gate transistors in the Wiggler Circuits 9 for each electromagnet 322 in the array 404. The electromagnet array 404 is wired to form a plurality of arrays of electromagnet magnetic poles 410A, 410B on the motor stator 402 that spatially match the array of permanent magnetic poles 410 configured on the rotor wheel 412. The array of permanent magnet poles 410 on the rotor wheel 412 are comprised of composite ferromagnetic cores 300 wherein the metallic ferromagnetic elements 304 further comprise ferromagnetic compositions shown in Table III. Metallic ultra-low loss ferromagnetic materials useful in motor applications as permanent magnets because of their high saturation magnetization (>1 Tesla) and high remanent magnetization ≈80% of saturation magnetization are Neodymium Iron Boron (Nd₂Fe₁₂B), which has low permeability ranging between μᵣ=1.04 1.115 that exhibit high saturation fields and high coercivity. Samarium Cobalt is another alloy base useful in permanent magnet applications It has the same permeability as neodymium iron boron magnets, slightly lower remanence, but a much higher Curie temperature, making it suitable for higher temperature environments. Additives can be added to adjust properties to specifications favoring a given application.

The electromagnet arrays of magnetic poles 410A, 410B on the motor stator 402 are configured as an outer array of magnetic poles 410A and an inner array of magnetic poles 410B. The electromagnets 322 in the inner array or magnetic poles 410B are electrically connected to operate in reverse polarization to electromagnets 322 in the outer array of magnetic poles 410A. The outer array of magnetic poles 410A is configured to function as the primary or forward drive, whereas the inner array of magnetic poles 410B is configured to function as the reverse and breaking system. The electromagnets 322 that form the arrays of magnetic poles 410A, 410B and plurality of layers 408 are designed to function as the stator in the electric motor 400.

As shown in FIG. 5D, the circuitry of the motor stator 402 is partitioned to locate system control circuitry in a central partition 416. The system control circuitry in the central partition 416 regulates all current flowing through the arrays of magnetic poles 410, 410A, 410B. Currents are modulated for the cycle frequency and amplitude to vary the motor's rotational speed and torque. The power control circuits may operate with synchronous or asynchronous modulation.

Active circuitry within the inner ring 418 pertains to fully integrated power inverter circuitry pertaining to reverse drive and breaking actions of the motor stator's power drive unit. Active circuitry within the outer ring 420 pertains to fully integrated power inverter circuitry pertaining to the forward drive actions of the motor stator's power drive unit.

FIG. 5E depicts a partial cross-sectional view of the electric motor 400 wherein the motor rotor wheel 412 is depicted opposite and above to the array of electromagnets 410A. 410B on motor stator 402. To maximize linkage flux, φ₁, anti-ferromagnetic material 422 is applied to the exterior surfaces of the electromagnets 322 and permanent magnets in the arrays of poles 410, 410A, 410B to minimize leakage flux running into the space between the electromagnets 322 and the permanent 410. Anti-ferromagnetic materials have permeability, μᵣ=−1, and induce flux lines that are oriented in the opposite direction of the applied or generate magnetic field lines. Therefore, flux lines originating from an N-pole element will be neutralized in the regions of anti-ferromagnetic material 422 that is applied between N and S regions within the arrays of electromagnet poles 410A, 410B and permanent poles 410. This fringe flux neutralization strengthens the magnetic coupling between the interior regions 424 within the poles of electromagnets 322 and permanent magnets 410. An air gap 426 separates rotor 412 from the stator 402. A layer ranging in thickness 5 μm and 5 mm of ultra-low loss amorphous silica 428 is applied to the magnetically interacting surfaces of the rotor 412 and the stator 402. The combination of fringing flux neutralization caused by the anti-ferromagnetic materials 422 and the ultra-low amorphous silica layers 428 creates regions of maximal flux linkage interactions 430 to improve the efficiency of the motor 400.

### EXEMPLARY EMBODIMENTS/ASPECTS

a. A fully integrated power inverter that comprises a DC input electrode in electrical communication with a Wiggler circuit through a first fully integrated layer comprising four parallel resistors and first conductive means embedded within a low-loss dielectric insulator that has high voltage dielectric breakdown, wherein,
   the first conductive means makes a vertical electrical connection from the DC input electrode to the center-tap winding of a primary coil in a transformer that comprises a magnetic core and the transformer is fully embedded within a second fully integrated layer within a low-loss dielectric insulator that sustains high dielectric breakdown voltages,
   the four parallel resistors make vertical electrical connection from the DC input electrode to second conductive means formed on a planarized surface on which a second fully integrated layer is formed, such that;
   the second fully integrated layer comprises polarized capacitors embedded within a dielectric insulator that are in simultaneous electrical communication with second conductive means in contact with parallel resistors and the DC Input and the center tap winding of the primary coil of the transformer, and
   the second fully integrated layer further comprises a transformer and conductive means embedded within a dielectric insulator that electrically connects the Wiggler circuit to both electrodes of the transformer's primary coil, and provides electrical contact to the output electrodes of the transformer's secondary coil, wherein
   active circuitry comprising power control transistors and Power FETs with conductive means that make electrical connection to ground and provide vertical connections that connect the drain electrodes of Power FETs to the input electrodes of transformer's primary coil, connect the drain electrodes of power control transistors to ground, connect, the source electrode of the Power FET to ground, connect the source electrodes of the power control transistors to the gate electrodes of the Power FETs and the polarized capacitors and parallel resistors, while connecting the parallel resistors and polarized capacitors to the gate electrodes of the power control transistors.
b. A fully integrated power inverter in a, wherein the conductive means comprises a metallic conductor.
c. A fully integrated power inverter in a, wherein the conductive means comprises a conducting ceramic.
d. A fully integrated power inverter in c, wherein the conducting ceramic is a superconducting ceramic.
e. A fully integrated power inverter in a, wherein transformer is a toroidal transformer.
f. A fully integrated power inverter in e, wherein the toroidal transformer comprises a primary coil with serial windings interleaved with a secondary coil configured with parallel windings.
g. A toroidal transformer in f, wherein the primary coil comprises electrically conductive means that interconnects primary coil windings through a series connection that runs circumferentially around the outer or inner regions of the toroidal magnetic core.
h. A toroidal transformer in f, wherein the secondary coil comprises electrically conductive means that interconnects secondary windings through a parallel interconnection that runs circumferentially around the inner or outer regions of the toroidal magnetic core.
i. A toroidal transformer as in a, wherein insulating material that has high resistivity and can sustain high dielectric breakdown voltages is applied to electrically isolate coil winding from each other and metallic elements in the magnetic core.
j. An insulator as in i, wherein the insulating material is amorphous silica.
k. A fully integrated power inverter as in a, wherein the dielectric insulator is amorphous silica.
l. A fully integrated power inverter as n a, wherein the magnetic core comprises a magnetic ceramic compound.
m. A fully integrated power inverter as in a, wherein the transformer's magnetic core comprises a composite ferromagnetic core consisting of a layered integrated body further comprising: metallic ferromagnetic compositions separated by extreme resistivity amorphous silica layers.
n. A fully integrated power inverter as in m, wherein the extreme resistivity amorphous silica layers or integral members are oriented such that their major surfaces are perpendicular to the magnetic field lines induced within the magnetic core.
o. A fully integrated power inverter as in m, wherein the transformer's magnetic core comprises a composite ferromagnetic core consisting of at least one integral amorphous silica layer
p. A composite ferromagnetic core as in m, wherein the at least one integral extreme resistivity amorphous silica layer has thickness ranging from 1 nm to 100 nm.
q. A fully integrated power inverter as in a, wherein the transformer's primary coil comprises at least one strong coupling coil winding that is adjacent to an extreme resistivity amorphous silica integral body member.
r. The extreme resistivity amorphous silica integral body member of q that has thickness that substantially matches the width of the at least one strong coupling coil winding.
s. A fully integrated power inverter as in a, wherein the transformer's secondary coil comprises at least one strong coupling coil winding that is adjacent to an extreme resistivity amorphous silica integral body member.
t. The extreme resistivity amorphous silica integral body member of s that has thickness that substantially matches the width of the at least one strong coupling coil winding.
u. A fully integrated power inverter as in a, wherein at least one of the coils comprising the transformer comprises anti-ferromagnetic material located in positions that reduce flux densities that contribute fringing field losses within said at least one of the coils.
v. The composite ferromagnetic core as in m, wherein the metallic ferromagnetic composition comprises as base allow consisting of iron (Fe), nickel (Ni), or manganese (Mn).
w. The metallic ferromagnetic composition as in v, wherein the base alloy further comprises alloying additives consisting of at least one of the following elements: copper (Cu), chromium (Cr), molybdenum (Mo), zinc (Zn), silicon (Si), cobalt (Co), phosphorous (P), boron (B), tantalum (Ta), niobium (Nb) or zirconium (Zr).
x. The metallic ferromagnetic core as in w, wherein the microstructure of the metallic ferromagnetic core comprises a matrix of uniformly sized grains ranging between 5-7 μm to minimize residual loss within the metallic ferromagnetic core.
y. The fully integrated power inverter as in a, wherein the capacitors ultra-high energy dielectric layers that have layer thickness ≤100 nm thick.
z. The fully integrated power inverter as in y, wherein the capacitors comprise titanate perovskite electroceramic dielectric having compositions consisting of:

M^{(I)}_{(1-x-y-z)}M^{(II)}₍ₓ₎M^{(III)}_{(y)}M^{(IV)}_{(z)}Zr_{(1-a-b)}Hf_{(b)}Ti₍ₐ₎O₃
wherein Zr is zirconium, Hf is hafnium, Ti is titanium and M (I), M (II), M (III), M (IV) are additional metal oxide components that form a thermodynamically stable perovskite crystal, selected such that the atomic mass unit (amu) of the unit cell of perovskite ceramic is perovskite ceramic is ≥25 amu;
wherein the additional metal oxide components are selected from the group consisting of transition metal elements scandium (Sc), vanadium (V), chromium (Cr), manganese (Mn), zinc (Zn), yttrium (Y), niobium (Nb), tantalum (Ta) or tungsten (W);
lanthanide metal elements: lanthanum (La), cerium (Ce), praseodymium (Pr), neodymium (Nd), samarium (Sm), europium (Eu), gadolinium (Gd), terbium (Tb), dysprosium (Dy), holmium (Ho), Ytterbium (Yb) and thorium (Th) and, post transition metal elements consisting of: indium (In), tin (Sn), lead (Pb), and bismuth (Bi).
aa. The titanate perovkite ceramic as in z wherein the microstructure comprises a matrix of uniformly sized polycrystalline grains having physical diameter that is ≤50 nm.
bb. The titanate pervoskite ceramic as in aa, wherein the microstructure comprises polycrystalline grain boundaries further comprising amorphous silica. 15
cc. The titanate perovskite ceramic as in bb, wherein the polycrystalline grain boundaries are 2-10 nm thick.
dd. The fully integrated power inverter as in y, wherein the capacitors comprise niobate perovskite electroceramic dielectric having compositions consisting of:

M^{(I)}_{(1-x-y-z)}M^{(II)}₍ₓ₎M^{(III)}_{(y)}M^{(IV)}_{(z)}Zr_{(1-a-b)}Hf_{(b)}Ti₍ₐ₎O₃
wherein Zr is zirconium, Hf is hafnium, Nb is niobium and M^{(I)}, M^{(II)}, M^{(III)}, M^{(IV)} are additional metal oxide components that form a thermodynamically stable perovskite crystal, selected such that the atomic mass unit (amu) of the unit cell of perovskite ceramic is perovskite ceramic is ≥25 amu;
wherein the additional metal oxide components are selected from the group consisting of transition metal elements scandium (Sc), vanadium (V), chromium (Cr), manganese (Mn), zinc (Zn), yttrium (Y), titanium (Ti), tantalum (Ta) or tungsten (W);
lanthanide metal elements: lanthanum (La), cerium (Ce), praseodymium (Pr), neodymium (Nd), samarium (Sm), europium (Eu), gadolinium (Gd), terbium (Tb), dysprosium (Dy), holmium (Ho), Ytterbium (Yb) and thorium (Th)
and, post transition metal elements consisting of: indium (In), tin (Sn), lead (Pb), and bismuth (Bi).
ee. The niobate perovskite ceramic as in dd wherein the microstructure comprises a matrix of uniformly sized polycrystalline grains having physical diameter that is ≤50 nm.
ff. The niobate perovskite ceramic as in ee, wherein the microstructure comprises polycrystalline grain boundaries further comprising amorphous silica. 5
gg. The niobate perovskite ceramic as in ff, wherein the polycrystalline grain boundaries are 2-10 nm thick.
hh. The fully integrated power inverter as in a, wherein the capacitors comprise tantalate perovskite electroceramic dielectric having compositions consisting of:

M^{(I)}_{(1-x-y-z)}M^{(II)}₍ₓ₎M^{(III)}_{(y)}M^{(IV)}_{(z)}Zr_{(1-a-b)}Hf_{(b)}Ti₍ₐ₎O₃
wherein Zr is zirconium, Hf is hafnium, Ta is tantalum and M (I), M (II), M (III), M (IV) are additional metal oxide components that form a thermodynamically stable perovskite crystal, selected such that the atomic mass unit (amu) of the unit cell of perovskite ceramic is ≥25 amu;
wherein the additional metal oxide components are selected from the group consisting of
transition metal elements scandium (Sc), vanadium (V), chromium (Cr), manganese (Mn), zinc (Zn), yttrium (Y), niobium (Nb), titanium (Ti) or tungsten (W);
lanthanide metal elements: lanthanum (La), cerium (Ce), praseodymium (Pr), neodymium (Nd), samarium (Sm), europium (Eu), gadolinium (Gd), terbium (Tb), dysprosium (Dy), holmium (Ho), Ytterbium (Yb) and thorium (Th)
and, post transition metal elements consisting of: indium (In), tin (Sn), lead (Pb), and bismuth (Bi).
ii. The tantalate perovskite ceramic as in hh, wherein the microstructure comprises a matrix of uniformly sized polycrystalline grains having physical diameter that is ≤50 nm.
jj. The tantalate perovskite ceramic as in ii, wherein the microstructure comprises polycrystalline grain boundaries further comprising amorphous silica.
kk. The tantalate perovskite ceramic as in ii, wherein the polycrystalline grain boundaries are 2-10 nm thick.
ll. The fully integrated power inverter as in a, wherein the parallel resistors comprise a single metal oxide element forming:
   a rutile crystal structure from the group of metal oxides consisting of copper oxide (CuO), nickel oxide (NiO), ruthenium oxide (RuO₂), iridium oxide (IrO₂), and osmium oxide (OsO₂)
   or comprise a single metal oxide element forming:
   a trigonal crystal structure from the group of metal oxides consisting of antimony oxide (Sb₂O₃) and rhodium oxide (Rh₂O₃), or comprise
   or comprise single metal oxide element forming:
   a cubic close-packed crystal structure from the group of metal oxides consisting of copper oxide (CuO) and nickel oxide (NiO).
mm. The fully integrated power inverter as in k, wherein the parallel resistors comprise two or more metal oxide components that adopt a pyrochlore crystal structure having composition M⁽¹⁾M⁽²⁾₂O₇, wherein M⁽¹⁾ represents on or more trivalent transition metal oxides from the group consisting of:
   scandium oxide (Sc₂O₃), titanium oxide (Ti₂O₃), vanadium oxide (V₂O₃), chromium oxide
   (Cr₂O₃), manganese oxide (Mn₂O₃), and iron oxide (Fe₂O₃);
   or more trivalent heavy-metal oxides consisting of:
   bismuth oxide (Bi₂O₃), lanthanum oxide (La₂O₃), cerium oxide (Ce₂O₃), lead oxide (PbO) and
   neodymium oxide (Nd₂O₃);
   and,
   M⁽²⁾ one or more of the primary oxides that would individually form a rutile crystal structure.
nn. The fully integrated power inverter in ll, wherein the parallel resistors comprise two or more metal oxide components that adopt a perovskite crystal structure having composition M⁽³⁾M⁽²⁾O₃, wherein
   M⁽²⁾ represents one or more of the primary metal oxides that would individually;
   and,
   preferred alkaline earth metal elements are drawn from the group consisting of magnesium oxide (MgO), calcium oxide (CaO), strontium oxide (SrO) and barium oxide (BaO).
oo. The fully integrated power inverter in a, wherein the power control transistors are resonant gate transistors.
pp. The fully integrated power inverter in a, wherein the power FETs are resonant gate transistors.
qq. The fully integrated power inverter in a, wherein the power control transistors and the power FETs are resonant gate transistors design to manage power levels in excess of 200 kilo-Watts.

### High Power Applications

rr. A fully integrated power inverter for high power applications wherein the active circuitry consisting of at least one Wiggler circuit comprising power control transistors and power FETs is integrated into a six inch (6″) or larger semiconductor wafer that is assembled, without singulating the active circuitry, into a fully integrated body that comprises a DC input electrode in electrical communication with at least one Wiggler circuit through a first fully integrated layer comprising four parallel resistors and first conductive means embedded within a low-loss dielectric insulator that has high voltage dielectric breakdown, wherein,
   the first conductive means makes a vertical electrical connection from the DC input electrode to the center-tap winding of a primary coil in a transformer that comprises a magnetic core and the transformer is fully embedded within a second fully integrated layer within a low-loss dielectric insulator that sustains high dielectric breakdown voltages,
   the four parallel resistors make vertical electrical connection from the DC input electrode to second conductive means formed on a planarized surface on which a second fully integrated layer is formed, such that;
   the second fully integrated layer comprises polarized capacitors embedded within a dielectric insulator that are in simultaneous electrical communication with second conductive means in contact with parallel resistors and the DC Input and the center tap winding of the primary coil of the transformer, and
   the second fully integrated layer further comprises a transformer and conductive means embedded within a dielectric insulator that electrically connects the Wiggler circuit to both electrodes of the transformer's primary coil, and provides electrical contact to the output electrodes of the transformer's secondary coil, wherein
   semiconducting wafer comprising power control transistors and Power FETs with conductive means that make electrical connection to ground and provide vertical connections that connect the drain electrodes of Power FETs to the input electrodes of transformer's primary coil, connect the drain electrodes of power control transistors to ground, connect, the source electrode of the Power FET to ground, connect the source electrodes of the power control transistors to the gate electrodes of the Power FETs and the polarized capacitors and parallel resistors, while connecting the parallel resistors and polarized capacitors to the gate electrodes of the power control transistors.
ss. The fully integrated power inverter for high power applications as in rr, wherein the fully integrated power inverter comprises a plurality of Wiggler circuits configured in parallel operation to manage the inversion of DC input power into AC output power.
tt. The fully integrated power inverter for high power applications in rr, wherein the power control transistors and power FETs are resonant gate transistors.
uu. The fully integrated power inverter for high power applications in tt, wherein each of the resonant gate transistors are designed to manage power loads greater than 200 kilo-Watts.
vv. The fully integrated power inverter for high power applications in tt, wherein the magnetic core comprising a composite ferromagnetic core consisting of metallic ferromagnetic core elements and layers of extreme resistivity amorphous silica.
ww. The magnetic core as in vv, wherein the metallic ferromagnetic core composition comprises a base allow consisting of iron (Fe), nickel (Ni), or manganese (Mn).
xx. The metallic ferromagnetic core composition as in v, wherein the base alloy further comprises alloying additives consisting of at least one of the following elements: copper (Cu), chromium (Cr), molybdenum (Mo), zinc (Zn), silicon (Si), cobalt (Co), phosphorous (P), boron (B), tantalum (Ta), niobium (Nb) or zirconium (Zr).
yy. The metallic ferromagnetic core as in xx, wherein the microstructure of the metallic ferromagnetic core comprises a matrix of uniformly sized grains ranging between 5-7 μm to minimize residual loss within the metallic ferromagnetic core.
zz. A fully integrated power inverter as in yy, wherein the transformers' primary coil comprises at least one strong coupling coil winding that is adjacent to an extreme resistivity amorphous silica integral body member.
aaa. A fully integrated power inverter as in rr, wherein the DC electrode is in electrical communication with a resonant energy storage device.

### Electromagnet

bbb. An electromagnet comprising
   a low loss composite ferromagnetic core, at least one metallic ferromagnetic core element and coil windings comprising electrical means circumferentially wound around the low-loss composite ferromagnetic core, wherein the composite ferromagnetic core additionally comprises extreme resistivity amorphous silica layers that have loss tangent in the range of tan δ in the range of 10⁻⁴ to 10⁻⁵, resistivity ρ≈10¹⁸ Ω-cm that reduce Eddy current losses within the composite ferromagnetic core.
ccc. An electromagnet as in bbb, wherein the at least one metallic ferromagnetic core element has a uniform distribution of polycrystalline grains with identical elemental composition and physical dimension that is less than 7 μm.
ddd. An electromagnet as in bbb, wherein the metallic core element layer has thickness ranging from 5 μm to 5 mm.
eee. An electromagnet as in bbb, wherein the thickness of the extreme resistivity amorphous silica layer embedded into the composite ferromagnetic core varies between 1 nm to 100 nm.
fff. An electromagnet as in eee, wherein the extreme resistivity amorphous silica layers are oriented such that their major surfaces are perpendicular to the magnetic field lines induced within the magnetic core.
ggg. An electromagnet as in bbb, wherein the metallic ferromagnetic core composition comprises a base allow consisting of iron (Fe), nickel (Ni), or manganese (Mn).
hhh. An electromagnet as in ggg, wherein the base alloy further comprises alloying additives consisting of at least one of the following elements: copper (Cu), chromium (Cr), molybdenum (Mo), zinc (Zn), silicon (Si), cobalt (Co), phosphorous (P), boron (B), tantalum (Ta), niobium (Nb) or zirconium (Zr).
iii. An electromagnet as in bbb, wherein the electromagnet comprises anti-ferromagnetic material located in positions that reduce flux densities that contribute fringing field losses within the coil windings.
jjj. An electromagnet as in bbb, wherein the composite core comprises an extreme resistivity amorphous silica integral body member that its major surface oriented perpendicular to magnetic field lines induced within the magnetic core and is adjacent to at least one strong coupling coil winding.
kkk. An electromagnet as in jjj, wherein the integral body member that is adjacent to the at least on strong coupling coil winding has thickness that substantially matches the width/diameter of the strong coupling coil winding.

lll. An electromagnet as in bbb, wherein the conductive means forming the coil windings is insulated from other conducting bodies with extreme resistivity amorphous silica that has loss tangent in a loss tangent in the range of tan δ=10⁻⁴ to 10⁻⁵, resistivity ρ≈10¹⁸ Ω-cm, and dielectric breakdown voltage on the order of 10 MegaVolts-cm-1 or 1,000 V-μm.
mmm. An electromagnet as in bbb, wherein the conductive means is an oxide ceramic.
nnn. An electromagnet as in lll, wherein the oxide ceramic is a ceramic superconductor.

### Transformer

ooo. A transformer comprising at least one electromagnet consisting of a low loss composite ferromagnetic core with at least one metallic ferromagnetic core element at least one primary and at least one secondary coil windings comprising electrical means circumferentially wound around the low-loss composite ferromagnetic core, wherein the low loss composite ferromagnetic core additionally comprises extreme resistivity amorphous silica layers that have loss tangent in the range of tan δ in the range of 10⁻⁴ to 10⁻⁵, resistivity ρ≈10¹⁸ Ω-cm that reduce Eddy current losses within the composite ferromagnetic core.
ppp. The transformer as in ooo, wherein the at least one metallic ferromagnetic core element has a uniform distribution of polycrystalline grains with identical elemental composition and have physical dimension that is uniformly sized and less than or equal to 7 μm.
qqq. The transformer as in ooo, wherein the metallic core element layer has thickness ranging from 5 μm to 5 mm.
rrr. The transformer as in ooo, wherein the thickness of the extreme resistivity amorphous silica layer embedded into the composite ferromagnetic core varies between 1 nm to 100 nm.
sss. The transformer as in rrr, wherein the extreme resistivity amorphous silica layers are oriented such that their major surfaces are perpendicular to the magnetic field lines induced within the magnetic core.
ttt. The transformer as in ooo, wherein the metallic ferromagnetic core composition comprises a base allow consisting of iron (Fe), nickel (Ni), or manganese (Mn).
uuu. The transformer as in ttt, wherein the base alloy further comprises alloying additives consisting of at least one of the following elements: copper (Cu), chromium (Cr), molybdenum (Mo), zinc (Zn), silicon (Si), cobalt (Co), phosphorous (P), boron (B), tantalum (Ta), niobium (Nb) or zirconium (Zr).
vvv. The transformer as in ooo, wherein the transformer comprises anti-ferromagnetic material located in positions that reduce flux densities that contribute fringing field losses within the coil windings.
www. The transformer as in ooo, wherein the composite core comprises an extreme resistivity amorphous silica integral body member that its major surface oriented perpendicular to magnetic field lines induced within the magnetic core and is adjacent to at least one strong coupling coil winding.
xxx. The transformer as in www, wherein the integral body member that is adjacent to the at least on strong coupling coil winding has thickness that substantially matches the width/diameter of the strong coupling coil winding.
yyy. The transformer as in xxx, wherein the strong coupling coil is the primary coil of the transformer.
zzz. The transformer as in xxx, wherein the strong coupling coil is the secondary coil of the transformer.
aaaa. The transformer as in ooo, wherein the conductive means forming the coil windings is insulated from other conducting bodies with extreme resistivity amorphous silica that has loss tangent in a loss tangent in the range of tan δ=10⁻⁴ to 10⁻⁵, resistivity ρ≈10¹⁸ Ω-cm, and dielectric breakdown voltage on the order of 10 MegaVolts-cm-1 or 1,000 V-μm.
bbbb. The transformer as in ooo, wherein the conductive means is an oxide ceramic.
cccc. An electromagnet as in bbbb, wherein the oxide ceramic is a ceramic superconductor.
dddd. The transformer as in ooo, wherein the composite ferromagnetic core and the at least one primary coil and at least one secondary coil form a toroidal geometry.
eeee. The transformer as in dddd, where the at least one primary coil is wound in series and the secondary coil has interleaved windings that are configured in parallel.
ffff. A toroidal transformer in dddd, wherein the primary coil comprises electrically conductive means that interconnects primary coil windings through a series connection that runs circumferentially around the outer or inner regions of the toroidal magnetic core.
gggg. A toroidal transformer in dddd, wherein the secondary coil comprises electrically conductive means that interconnects secondary windings through a parallel interconnection that runs circumferentially around the inner or outer regions of the toroidal magnetic core.
hhhh. A toroidal transformer as in a, wherein insulating material that has high resistivity and can sustain high dielectric breakdown voltages is applied to electrically isolate coil winding from each other and metallic elements in the magnetic core.

### Permanent Magnet

iiii. A low-loss permanent magnet comprising a low loss composite ferromagnetic core with at least one metallic ferromagnetic core element, wherein the low loss composite ferromagnetic core additionally comprises extreme resistivity amorphous silica layers that have loss tangent in the range of tan δ in the range of 10⁻⁴ to 10⁻⁵, resistivity ρ≈10¹⁸ Ω-cm that reduce Eddy current losses within the composite ferromagnetic core.
jjjj. The low loss permanent magnet as in iiii, metallic ferromagnetic core element has a uniform distribution of polycrystalline grains with identical elemental composition and physical dimension that is uniformly sized and less than or equal to 7 μm.
kkkk. The low-loss permanent magnet as in iiii, wherein the metallic core element layer has thickness ranging from 5 μm to 5 mm.
llll. The low-loss permanent magnet as in iiii, wherein the thickness of the extreme resistivity amorphous silica layer embedded into the composite ferromagnetic core varies between 1 nm to 100 nm.
mmmm. The low-loss permanent magnet as in llll, wherein the extreme resistivity amorphous silica layers are oriented such that their major surfaces are perpendicular to the magnetic field lines applied within the magnetic core.
nnnn. The low-loss permanent magnet as in iiii, wherein the metallic ferromagnetic core comprises a metallic composition of a base alloy consisting of neodymium (Nd), iron (Fe) and boron (B).
oooo. The low-loss permanent magnet as in nnnn, wherein the metallic ferromagnetic core element further comprises alloying additives of terbium (Tr), dysprosium (Dy), nickel (Ni) or manganese (Mn).
pppp. The low-loss permanent magnet as in iiii, wherein the metallic ferromagnetic core composition comprises a base allow consisting of samarium (Sm) and cobalt (Co).
qqqq. The low-loss permanent magnet of pppp, wherein the metallic ferromagnetic core element further comprises alloying additives of iron (Fe), copper (Cu), zirconium (Zr), strontium (Sr), aluminum (Al), nickel (Ni), cobalt (Co) or manganese (Mn).
rrrr. The low-loss permanent magnet of iiii, wherein anti-ferromagnetic anti-ferromagnetic material located in positions that reduce flux densities that contribute fringing field losses within the poles of the permanent magnet.

### Electric Motor

ssss. An electric motor comprising:
   a stator consisting of:
   a fully integrated power inverter, further comprising active circuitry, that is in electrical communication with a plurality of electromagnets configured as poles on one major surface and a DC source electrode on the opposing major surface, and,
   a rotor consisting of permanent magnets configured as opposing poles that magnetically interact with the stator's electromagnet.
tttt. The electric motor as in ssss, wherein the fully integrated power inverter's DC input electrode is in electrical communication with a resonant energy storage device.
uuuu. The stator as in ssss, wherein the electromagnets further comprise a composite ultra-low loss ferromagnetic core, additionally comprising at least one metallic magnetic core element with embedded layers of extreme resistivity amorphous silica.
vvvv. The electromagnets as in uuuu, wherein the metallic magnetic core element has uniform polycrystalline grain size that is less than or equal to 7 micron.
wwww. The electromagnets as in vvvv, wherein the metallic magnetic core element(s) consists of an alloy comprising iron (Fe), nickel (Ni) or manganese (Mn).
xxxx. The electromagnet as in wwww, wherein the alloy forming the magnetic core element(s) further comprises alloying additives from the group consisting of copper (Cu), chromium (Cr), molybdenum (Mo), zinc (Zn), silicon (Si), cobalt (Co), phosphorous (P), boron (B), tantalum (Ta), niobium (Nb), or zirconium (Zr).
yyyy. The rotor as in ssss, wherein the permanent magnet comprises a composite ultra-low loss ferromagnetic core, additionally comprising a metallic magnetic core element with embedded layers of extreme resistivity amorphous silica.
zzzz. The permanent magnet as in yyyy wherein the metallic magnetic core element has uniform polycrystalline grain size that is less than or equal to 7 micron.
aaaaa. The permanent magnet as in yyyy, wherein the metallic magnetic core element(s) consist(s) of a metal alloy comprising neodymium (Nd), iron (Fe) and boron (B).
bbbbb. The permanent magnet as in aaaaa, wherein the metal alloy further comprises one or more alloying additives from the group consisting of terbium (Tr), dysprosium (Dy), nickel (Ni), or manganese (Mn).
ccccc. The permanent magnet as in bbbbb, wherein the metallic magnetic core element(s) consist(s) of metal alloy comprising samarium (Sm) and cobalt (Co).
ddddd. The permanent magnet as in ccccc, wherein the metal alloy further comprises one or more alloying additives from the group consisting of iron (Fe), copper (Cu), zinc (Zn), strontium (Sr), aluminum (Al), nickel (Ni), cobalt (Co) or manganese (Mn).
eeeee. The rotor as in uuuu, wherein the thickness of the extreme resistivity amorphous silica layer ranges between 1 nm and 100 nm.
fffff. The rotor as in uuuu, wherein the major surface of the extreme resistivity amorphous silica layer is oriented perpendicular to the induced or applied magnetic field lines within the composite ferromagnetic core.
ggggg. The motor as n ssss, wherein anti-ferromagnetic material is applied to exterior surfaces of the electromagnets and permanent magnets in the arrays of poles to minimize leakage flux running into the space between the electromagnets and between the space between the permanent magnets so as to strengthen the linkage flux in the gap between the rotor and the stator.
hhhhh. The motor as in ssss, wherein the top surface of electromagnets in the stator are coated with a layer of extreme resistivity ultra-low-loss amorphous silica to the magnetically interacting surfaces of the rotor and the stator.
iiiii. The motor as in ssss, wherein the fully integrated power inverter comprises active circuitry embedded within a semiconductor wafer that is not singulated or diced prior to assembly into the motor.
jjjjj. The motor as n iiiii, wherein semiconductor wafer comprises active circuitry partitioned into at least three partitions to place motor system control circuitry in the central region of the fully integrated semiconductor wafer, to locate circuitry relating to the forward drive within one of two outer rings, preferable the partitioned outer ring for maximal torque generation, and to place the reverse drive and breaking system in one of the other remaining partitions.
kkkkk. The motor as in jjjjj, wherein motor system control active circuitry regulates currents flowing the motor's electromagnets to operate in with synchronous or asynchronous modulation by modulating current amplitude and or current frequency.
lllll. The motor as in ssss, wherein ceramic capacitors forming Wiggler circuits within the power inverter comprise ultra-high energy density ceramic dielectric.
mmmmm. The capacitors as in lllll, wherein the ultra-high energy density ceramic dielectric comprise uniform composition and grain structure such that all electroceramic grains have uniform physical size that is less than or equal to 50 nm,
nnnnn. The ultra-high energy density ceramic dielectric as in mmmmm, wherein the uniformly sized grains have grain boundary material comprising extreme-resistivity amorphous silica.
ooooo. The ultra-high energy density ceramic dielectric as in nnnnn, wherein the grain boundary material thickness ranges between 2 nm and 10 nm in thickness.
ppppp. The capacitor as in mmmmm, wherein ultra-high energy ceramic dielectric is comprised of an electroceramic that has an average atomic mass unit in excess of 25 amu.
qqqqq. The motor as in ssss, wherein the active circuitry comprises at least one resonant gate transistor that operates as a power FET.
rrrrr. The motor as in ssss, wherein the active circuitry comprises at least on resonant gate transistor that operates as a power control transistor.
sssss. The motor as in ssss, wherein a plurality of fully integrated power inverters are embedded within the active circuitry.
ttttt. The motor as in ppppp, wherein the active circuitry regulates generated power in excess of 250 Kilo-Watts.
uuuuu. The motor as in ppppp, wherein the active circuitry regulates generated torque in excess of 600 Newton-meters.
vvvvv. The composite ultra-low loss ferromagnetic core as in uuuu, wherein the ferromagnetic core element(s) have thickness ranging from 5 micron to 5 millimeter.
wwwww. The motor as in ssss, wherein the fully integrated power inverter comprises a transformer further comprising at least one strong coupling coil winding that is adjacent to an amorphous silica integral body member within a composite ferromagnetic core internal to the transformer.
xxxxx. The strong coupling coil winding of wwwww, wherein said strong coupling coil winding is part of the transformer's primary coil.
yyyyy. The strong coupling coil winding of wwwww, wherein said strong coupling coil winding is part of the transformer's secondary coil.
zzzzz. The motor as in ssss, wherein the fully integrated power comprises a transformer that is a toroidal transformer.
aaaaaa. The toroidal transformer of zzzzz, wherein the transformer comprises one primary coil is wound in series and the secondary coil has interleaved windings that are configured in parallel.
bbbbbb. The motor as in ssss, wherein conductive means within the fully integrated power inverter, stator and rotor is a conducting ceramic.
cccccc. The conductive means in bbbbbb, wherein the conducting ceramic is a superconductor.
dddddd. The motor as in ssss, wherein extreme resistivity amorphous silica is used to insulate conductive means within the motor.
eeeeee. The motor as in ssss, wherein a anti-ferromagnetic material is applied to minimize flux fringing losses in the transformer element of a fully integrated power inverter.

### Method to Manufacture

ffffff. A method to construct a fully integrated power inverter, wherein an input electrode is used as a substrate or is formed on a sacrificial substrate using aerosol sprays of zero-volatility liquid metalorganic acid salt precursors of the desired component, wherein, an organic-laden glassy solid-solution is initially formed on a substrate by spray depositing a nonvolatile metalorganic acid salt solution on a substrate heated to 259 °C to 425 °C; through a mechanical mask when a patterned deposit is despired;
   metals weight percentage is solution is adjusted to compensate for molar ratio losses of a given element desired in the sprayed deposit;
   a reducing gas environments comprising hydrogen (H₂) or carbon monoxide (CO) within an inert gas or a mixture of inert gases comprising helium (He), nitrogen (N₂), argon (Ar) is used to spray deposit a metallic, semiconducting, or semi-metal element or compound at substrate temperatures,
   an oxidizing gas environment (air, oxygen (O₂), adequate ratios of carbon dioxide to carbon monoxide (CO₂)/CO) when a oxide deposit is desired,
   wherein,
   the organic-laden deposit is heat treated to remove the organic residue:
   and,
   the heat treated deposit is then subjected to a rapid thermal annealing treatment in an appropriate plasma gas environment to preserve the desired compound (oxide or elemental) and evolve the desire grain size:
   wherein further,
   the process is repeated to form the desired patterned deposit structure,
   until
   the desired integrated passive circuit structure is achieved;
   after which,
   an overcoat of an insulating material, preferably amorphous silica, is deposited and planarized to form the next circuit layer of metallic and dielectric patterned layers to form an additional circuit layer;
   such that a final layer complete with vertical interconnects is formed.
gggggg. The method as in ffffff, wherein active circuitry is bounded to the top of a planarized layer as discrete circuit elements or a fully integrated wafer, and the bounded active circuitry is embedded within an insulating material, preferably amorphous silica that is planarized to expose vertical interconnections before a final metallic layer is deposited to make ground and output ports on top of the structure.

All patents, published applications, and references mentioned herein are hereby incorporated by reference in their entirety as if each individual patent, published application, or reference was specifically and individually indicated to be incorporated by reference. In case of conflict, the present application, including any definitions herein, will control.

While specific aspects and embodiments of the subject disclosure have been discussed, the above specification is illustrative and not restrictive. Many variations of the disclosure will become apparent to those skilled in the art upon review of this specification and the claims below. The full scope of the disclosure should be determined by reference to the claims, along with their full scope of equivalents, and the specification, along with such variations.

While example embodiments have been particularly shown and described, it will be understood by those skilled in the art that various changes in form and details may be made therein without departing from the scope of the embodiments encompassed by the appended claims.

What is claimed:

1. A fully integrated power inverter that comprises a DC input electrode in electrical communication with a Wiggler circuit through a first fully integrated layer comprising four parallel resistors and first conductive means embedded within a low-loss dielectric insulator that has high voltage dielectric breakdown, wherein,
the first conductive means makes a vertical electrical connection from the DC input electrode to the center-tap winding of a primary coil in a transformer that comprises a magnetic core and the transformer is fully embedded within a second fully integrated layer within a low-loss dielectric insulator that sustains high dielectric breakdown voltages,
the four parallel resistors make vertical electrical connection from the DC input electrode to second conductive means formed on a planarized surface on which a second fully integrated layer is formed, such that;
the second fully integrated layer comprises polarized capacitors embedded within a dielectric insulator that are in simultaneous electrical communication with second conductive means in contact with parallel resistors and the DC Input and the center tap winding of the primary coil of the transformer, and
the second fully integrated layer further comprises a transformer and conductive means embedded within a dielectric insulator that electrically connects the Wiggler circuit to both electrodes of the transformer's primary coil, and provides electrical contact to the output electrodes of the transformer's secondary coil, wherein
active circuitry comprising power control transistors and Power FETs with conductive means that make electrical connection to ground and provide vertical connections that connect the drain electrodes of Power FETs to the input electrodes of transformer's primary coil, connect the drain electrodes of power control transistors to ground, connect, the source electrode of the Power FET to ground, connect the source electrodes of the power control transistors to the gate electrodes of the Power FETs and the polarized capacitors and parallel resistors, while connecting the parallel resistors and polarized capacitors to the gate electrodes of the power control transistors.

2. A fully integrated power inverter in claim 1, wherein the conductive means comprises a metallic conductor.

3. A fully integrated power inverter in claim 1, wherein the conductive means comprises a conducting ceramic.

4. A fully integrated power inverter in claim 3, wherein the conducting ceramic is a superconducting ceramic.

5. A fully integrated power inverter in claim 1, wherein transformer is a toroidal transformer.

6. A fully integrated power inverter in claim 5, wherein the toroidal transformer comprises a primary coil with serial windings interleaved with a secondary coil configured with parallel windings.

7. A toroidal transformer in claim 6, wherein the primary coil comprises electrically conductive means that interconnects primary coil windings through a series connection that runs circumferentially around the outer or inner regions of the toroidal magnetic core.

8. A toroidal transformer in claim 6, wherein the secondary coil comprises electrically conductive means that interconnects secondary windings through a parallel interconnection that runs circumferentially around the inner or outer regions of the toroidal magnetic core.

9. A fully integrated power inverter for high power applications wherein the active circuitry consisting of at least one Wiggler circuit comprising power control transistors and power FETs is integrated into a six inch (6″) or larger semiconductor wafer that is assembled, without singulating the active circuitry, into a fully integrated body that comprises a DC input electrode in electrical communication with at least one Wiggler circuit through a first fully integrated layer comprising four parallel resistors and first conductive means embedded within a low-loss dielectric insulator that has high voltage dielectric breakdown, wherein,
the first conductive means makes a vertical electrical connection from the DC input electrode to the center-tap winding of a primary coil in a transformer that comprises a magnetic core and the transformer is fully embedded within a second fully integrated layer within a low-loss dielectric insulator that sustains high dielectric breakdown voltages,
the four parallel resistors make vertical electrical connection from the DC input electrode to second conductive means formed on a planarized surface on which a second fully integrated layer is formed, such that;
the second fully integrated layer comprises polarized capacitors embedded within a dielectric insulator that are in simultaneous electrical communication with second conductive means in contact with parallel resistors and the DC Input and the center tap winding of the primary coil of the transformer, and
the second fully integrated layer further comprises a transformer and conductive means embedded within a dielectric insulator that electrically connects the Wiggler circuit to both electrodes of the transformer's primary coil, and provides electrical contact to the output electrodes of the transformer's secondary coil, wherein
semiconducting wafer comprising power control transistors and Power FETs with conductive means that make electrical connection to ground and provide vertical connections that connect the drain electrodes of Power FETs to the input electrodes of transformer's primary coil, connect the drain electrodes of power control transistors to ground, connect, the source electrode of the Power FET to ground, connect the source electrodes of the power control transistors to the gate electrodes of the Power FETs and the polarized capacitors and parallel resistors, while connecting the parallel resistors and polarized capacitors to the gate electrodes of the power control transistors.

10. The fully integrated power inverter for high power applications as in claim 9, wherein the fully integrated power inverter comprises a plurality of Wiggler circuits configured in parallel operation to manage the inversion of DC input power into AC output power.

11. An electromagnet comprising
a low loss composite ferromagnetic core, at least one metallic ferromagnetic core element and coil windings comprising electrical means circumferentially wound around the low-loss composite ferromagnetic core, wherein the composite ferromagnetic core additionally comprises extreme resistivity amorphous silica layers that have loss tangent in the range of tan δ in the range of 10⁻⁴ to 10⁻⁵, resistivity ρ≈10¹⁸ Ω-cm that reduce Eddy current losses within the composite ferromagnetic core.

12. An electromagnet as in claim 11, wherein the at least one metallic ferromagnetic core element has a uniform distribution of polycrystalline grains with identical elemental composition and physical dimension that is less than 7 μm.

13. A transformer comprising at least one electromagnet consisting of a low loss composite ferromagnetic core with at least one metallic ferromagnetic core element at least one primary and at least one secondary coil windings comprising electrical means circumferentially wound around the low-loss composite ferromagnetic core, wherein the low loss composite ferromagnetic core additionally comprises extreme resistivity amorphous silica layers that have loss tangent in the range of tan δ in the range of 10⁻⁴ to 10⁻⁵, resistivity ρ≈10¹⁸ Ω-cm that reduce Eddy current losses within the composite ferromagnetic core.

14. The transformer as in claim 13, wherein the at least one metallic ferromagnetic core element has a uniform distribution of polycrystalline grains with identical elemental composition and have physical dimension that is uniformly sized and less than or equal to 7 μm.

15. A low-loss permanent magnet comprising a low loss composite ferromagnetic core with at least one metallic ferromagnetic core element, wherein the low loss composite ferromagnetic core additionally comprises extreme resistivity amorphous silica layers that have loss tangent in the range of tan d in the range of 10⁻⁴ to 10⁻⁵, resistivity ρ≈10¹⁸ Ω-cm that reduce Eddy current losses within the composite ferromagnetic core.

16. The low loss permanent magnet as in claim 15, metallic ferromagnetic core element has a uniform distribution of polycrystalline grains with identical elemental composition and physical dimension that is uniformly sized and less than or equal to 7 μm.

17. An electric motor comprising:
a stator consisting of:
a fully integrated power inverter, further comprising active circuitry, that is in electrical communication with a plurality of electromagnets configured as poles on one major surface and a DC source electrode on the opposing major surface,
and,
a rotor consisting of permanent magnets configured as opposing poles that magnetically interact with the stator's electromagnet.

18. The electric motor as in claim 17, wherein the fully integrated power inverter's DC input electrode is in electrical communication with a resonant energy storage device.

19. A method to construct a fully integrated power inverter, wherein an input electrode is used as a substrate or is formed on a sacrificial substrate using aerosol sprays of zero-volatility liquid metalorganic acid salt precursors of the desired component, wherein, an organic-laden glassy solid-solution is initially formed on a substrate by spray depositing a nonvolatile metalorganic acid salt solution on a substrate heated to 259 °C to 425 °C; through a mechanical mask when a patterned deposit is despired;
metals weight percentage is solution is adjusted to compensate for molar ratio losses of a given element desired in the sprayed deposit;
a reducing gas environments comprising hydrogen (H₂) or carbon monoxide (CO) within an inert gas or a mixture of inert gases comprising helium (He), nitrogen (N₂), argon (Ar) is used to spray deposit a metallic, semiconducting, or semi-metal element or compound at substrate temperatures,
an oxidizing gas environment (air, oxygen (O₂), adequate ratios of carbon dioxide to carbon monoxide (CO₂)/CO) when a oxide deposit is desired,
wherein,
the organic-laden deposit is heat treated to remove the organic residue:
and,
the heat treated deposit is then subjected to a rapid thermal annealing treatment in an appropriate plasma gas environment to preserve the desired compound (oxide or elemental) and evolve the desire grain size:
wherein further,
the process is repeated to form the desired patterned deposit structure,
until
the desired integrated passive circuit structure is achieved;
after which,
an overcoat of an insulating material, preferably amorphous silica, is deposited and planarized to form the next circuit layer of metallic and dielectric patterned layers to form an additional circuit layer;
such that a final layer complete with vertical interconnects is formed.

20. The method as in claim 19, wherein active circuitry is bounded to the top of a planarized layer as discrete circuit elements or a fully integrated wafer, and
the bounded active circuitry is embedded within an insulating material, preferably amorphous silica that is planarized to expose vertical interconnections before a final metallic layer is deposited to make ground and output ports on top of the structure.
